(19) United States
(12) Patent Application Publication
(10) Pub. No.: US 2011/0268833 A1
(43) Pub. Date: Nov. 3, 2011

(54) NONCONFORMING ANTI-SLICE BALL

(75) Inventors: David L. Felker, Escondido, CA (US); Douglas C. Winfield, Madison, AL (US)

(73) Assignee: AERO-X GOLF INC., Escondido, CA (US)

(21) Appl. No.: 13/096,987

(22) Filed: Apr. 28, 2011

Related U.S. Application Data
(60) Provisional application No. 61/328,927, filed on Apr. 28, 2010.

(51) Int. Cl. B29C 33/00; B29D 99/00

(52) U.S. Cl. 425/470

(57) ABSTRACT

A non-conforming golf ball has a plurality of dimples formed on the outer surface of the ball in a predetermined dimple pattern, the outer surface comprising one or more first areas which include a plurality of first dimples which together have a first dimple volume and at least one second area having a dimple volume less that the first dimple volume, the first and second areas being configured to establish a preferred spin axis. The second area may be a band around the equator which has a lower dimple volume or no dimples, with the polar regions have a higher volume of dimples, creating a preferred spin axis through the poles.

### RELATED APPLICATIONS INFORMATION

This application claims the benefit under §119(e) of U.S. Provisional Application Ser. No. 61/328,927 filed Apr. 28, 2010 and entitled “Nonconforming Anti-Slice Ball,” which is incorporated herein by reference in its entirety as if set forth in full.

### BACKGROUND

1. Field of the Invention

The embodiments described herein relate generally to golf balls and are specifically concerned with golf ball dimple patterns to create desired flight characteristics.

2. Related Art

Golf ball dimple pattern design has long been considered a critical factor in ball flight distance % A golf ball's velocity, launch angle, and spin rate is determined by the impact between the golf club and the golf ball, but the ball's trajectory after impact is controlled by gravity and aerodynamics of the ball. Dimples on a golf ball affect both drag and lift, which in turn determine how far the ball flies.

The aerodynamic forces acting on a golf ball during flight may be determined according to well-understood laws of physics. Scientists have created mathematical models so as to understand these laws and predict the flight of a golf ball. Using these models along with several readily determined values such as the golf ball's weight, diameter and lift and drag coefficients, scientists have been able to resolve these aerodynamic forces into the orthogonal components of lift and drag. The lift coefficient relates to the aerodynamic force component acting perpendicular to the path of the golf ball during flight while the drag coefficient relates to the aerodynamic force component acting parallel to the flight path. The lift and drag coefficients vary by golf ball design and are generally a function of the speed and spin rate of the golf ball and for the most part do not depend on the orientation of the golf ball on the tee for a spherically symmetrical or “conforming” golf ball.

The maximum height a golf ball achieves during flight is directly related to the lift generated by the ball, while the direction that the golf ball takes, specifically how straight a golf ball flies, is related to several factors, some of which include spin and spin axis orientation of the golf ball in relation to the golf ball's direction of flight. Further, the spin and spin axis are important in specifying the direction and magnitude of the lift force vector. The lift force vector is a major factor in controlling the golf ball flight path in the x, y and z directions. Additionally, the total lift force a golf ball generates during flight depends on several factors, including spin rate, velocity of the ball relative to the surrounding air and the surface characteristics of the golf ball. However, with respect to surface characteristics, not all the regions on the surface of a spinning golf ball contribute equally to the generation of the total lift force. As an example, if the surface of the ball has a spherically symmetrical dimple pattern and the ball is hit so that the spin axis passes through the poles, the surface region closest to the golf ball equator (i.e., the great circle orthogonal to the spin axis) is more important in generating lift than are the regions close to the poles. However, a golf ball that is not hit squarely off the tee will tend to drill off-line and disperse away from its intended trajectory. This is often the case with recreational golfers who impart a slice or a hook spin on the golf ball when striking the ball.

In order to overcome the drawbacks of a hook or a slice, some golf ball manufacturers have modified the construction of a golf ball in ways that tend to lower the spin rate. Some of these modifications include utilizing hard two-piece covers and using higher moment of inertia golf balls. Other manufacturers have resorted to modifying the ball surface to decrease the lift characteristics on the ball. These modifications include varying the dimple patterns in order to affect the lift and drag on the golf ball.

Some prior golf balls have been designed with non-conforming or non-symmetrical dimple patterns in an effort to offset the effect of imperfect hits, so that the unskilled golfer can hit a ball more consistently in a straighter path. Although such balls are not legal in professional golf, they are very helpful for the recreational golfer in making the game more fun. One such ball is described in U.S. Pat. No. 3,819,190 of Nepela et. al. This ball is also known as a Polara™ golf ball, and has regions with different numbers of dimples or no dimples. A circumferential band extending around the spherical ball has a plurality of dimples, while polar areas on opposite sides of the band have few or no dimples. For this asymmetric golf ball, the measured lift and drag coefficients are strongly influenced by the orientation of the golf ball on the tee before it is struck. This is evidenced by the fact that the trajectory of the golf ball is strongly influenced by how the golf ball is oriented on the tee. For this ball to work properly, it must be placed on the tee with the poles of the ball oriented such that they are in the plane that is pointed in the intended direction of flight. In this orientation, the ball produces the lowest lift force and thus is less susceptible to hooking and slicing.

Other golf balls have been constructed of a single or multi-layer core, either solid or wound, that is tightly surrounded by a single or multilayer cover formed from polymeric materials, such as polyurethane, balata rubber, ionomers or a combination. Although some of these golf balls do reduce some hook and slice dispersion; this type of ball construction has the disadvantage of adding cost to the golf ball manufacturing process.

### SUMMARY

Certain embodiments as disclosed herein provide for a golf ball having a dimple pattern which results in reduced hook and slice dispersion.

In one aspect, a golf ball is designed with a dimple pattern which has reduced or no dimple volume in a selected circumferential band around the ball and more dimple volume in other regions of the ball. This causes the ball to have a “preferred” spin axis because of the weight differences caused by locating different volume dimples in different areas across the ball. This in turn reduces the tendency for dispersion of the ball to the left or right (hooking and slicing) during flight. In one example, the circumferential band of lower dimple volume is around the equator with more dimple volume in the polar regions. This creates a preferred spin axis passing through the poles. In one embodiment, the dimple pattern is also designed to exhibit relatively low lift when the ball spins in the selected orientation around its preferred spin axis. This golf ball is nonconforming or non-symmetrical under United States Golf Association (USGA) rules.

A golf ball's preferred or selected spin axis may also be established by placing high and low density materials in specific locations within the core or intermediate layers of the golf ball, but has the disadvantage of adding cost and complexity to the golf ball manufacturing process.

Where a circumferential band of lower or zero dimple volume is provided about the equator and more dimple volume is provided in the polar regions, a ball is created which has a large enough moment of inertia (MOI) difference between the poles horizontal (PH) orientation and other orientations that the ball has a preferential spin axis going through the poles of the ball. The preferred spin axis extends through the lowest weight regions of the ball. If these are the polar regions, the preferred axis extends through the poles. If the ball is oriented on the tee so that the “preferred axis” or axis through the poles is pointing up and down (pole over pole or POP orientation), it is less effective in correcting hooks and slices compared to being oriented in the PH orientation when struck.

In another aspect, the ball may have no dimples in a band about the equator (a land area) and deep dimples in the polar regions. The dimpleless region may be narrow, like a wide seam, or may be wider, i.e. equivalent to removing two or more rows of dimples next to the equator.

By creating a golf ball with a dimple pattern that has less dimple volume in a band around the equator and by removing more dimple volume from the polar regions adjacent to the low-dimple-volume band, a ball can be created with a large enough moment of inertia (MOI) difference between the poles-horizontal (PH) and other orientations that the ball has a “preferred” spin axis going through the poles of the ball and this preferred spin axis tends to reduce or prevent hooking or slicing when a golfer hits the ball in a manner which would generate other than pure backspin on a normal symmetrically designed golf ball. In other words, when this ball is hit in manner which would normally cause hooking or slicing in a symmetrical or conforming ball, the ball tends to rotate about the selected spin axis and thus not hook or slice as much as a symmetrical ball with no selected or “preferred” spin axis. In one embodiment, the dimple pattern is designed so that it generates relatively low lift when rotating in the PH orientation. The resulting golf ball displays enhanced hook and slice correcting characteristics.

The low volume dimples do not have to be located in a continuous band around the ball's equator. The low volume dimples could be interspersed with higher volume dimples, the band could be wider in some parts than others, the area in which the low volume dimples are located could have more land area (lack of dimples) than in other areas of the ball. The high volume dimples located in the polar regions could also be inter-dispersed with lower volume dimples; and the polar regions could be wider in some spots than others. The main idea is to create a higher moment of inertia for the ball when it is rotating in one configuration and to do this by manipulating the volume of the dimples across the surface of the ball. This difference in MOI then causes the ball to have a preferred spin axis. The golf ball is then placed on the tee so that the preferred spin axis is oriented approximately horizontally so that when the ball is hit with a hook or slice action, the ball tends to rotate about the horizontal spin axis and thus not hook or slice as much as a symmetrical ball with no preferred spin axis would hook or slice. In some embodiments, the preferred spin axis is the PH orientation.

Another way to create the preferred spin axis would be to place two or more regions of lower volume or zero volume regions on the ball's surface and make the regions somewhat co-planar so that they create a preferred spin axis. For example, if two areas of lower volume dimples were placed opposite each other on the ball, then a dumbbell-type weight distribution would exist. In this case, the ball has a preferred spin axis equal to the orientation of the ball when it is rotating end-over-end with the “dumbbell areas”.

The ball can also be oriented on the tee with the preferred spin axis tilted up to about 45 degrees to the right and then the ball still resists slicing, but does not resist hooking. If the ball is tilted 45 degrees to the left it reduces or prevents hook dispersion, but not slice dispersion. This may be helpful for untrained golfers who tend to hook or slice a ball. When the ball is oriented so that the preferred axis is pointing up and down on the tee (POP orientation for a preferred spin axis in the PH orientation), the ball is much less effective in correcting hooks and slices compared to being oriented in the PH orientation.

Other features and advantages will become more readily apparent to those of ordinary skill in the art after reviewing the following detailed description and accompanying drawings.

### BRIEF DESCRIPTION OF THE DRAWINGS

The details of the present embodiments, both as to structure and operation, may be gleaned in part by study of the accompanying drawings, in which like reference numerals refer to like parts, and in which:

FIG. 1 is a perspective view of one hemisphere of a first embodiment of a golf ball cut in half through the equator, illustrating a first dimple pattern designed to create a preferred spin axis, the opposite hemisphere having an identical dimple pattern;

FIG. 2 is a perspective view similar to FIG. 1 illustrating a second embodiment of a golf ball with a second, different dimple pattern;

FIG. 3 is a perspective view illustrating one hemisphere of a compression molding cavity for making a third embodiment of a golf ball with a third dimple pattern;

FIG. 4 is a perspective view similar to FIGS. 1 and 2 illustrating a fourth embodiment of a golf ball with a fourth dimple pattern;

FIG. 5 is a perspective view similar to FIGS. 1, 2 and 4 illustrating a fifth embodiment of a golf ball with a fifth dimple pattern;

FIG. 6 is a perspective view similar to FIGS. 1, 2, 4 and 5 illustrating a sixth embodiment of a golf ball having a different dimple pattern;

FIG. 7 is a perspective view similar to FIGS. 1, 2, and 4 to 6 illustrating a seventh embodiment of a golf ball having a different dimple pattern;

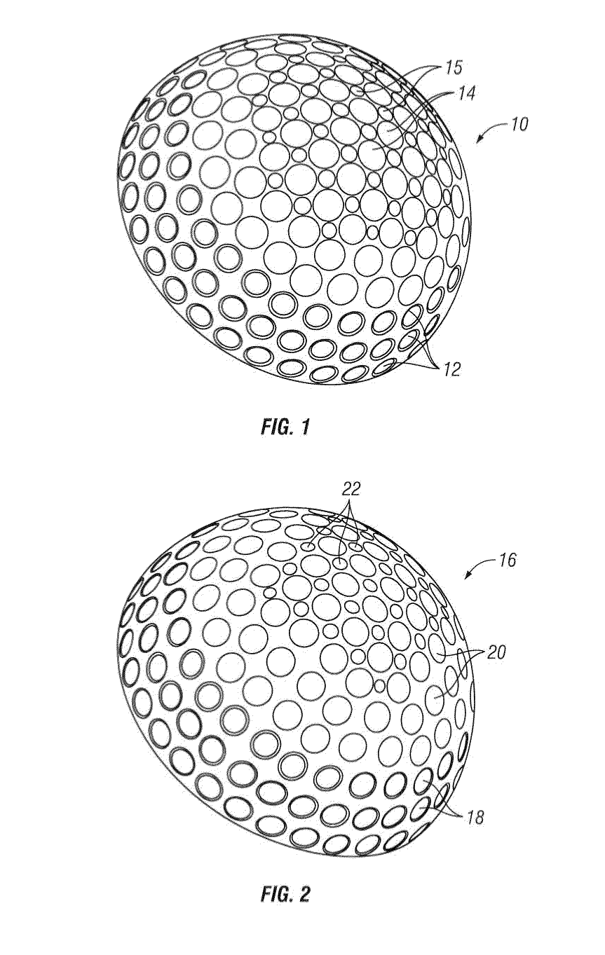

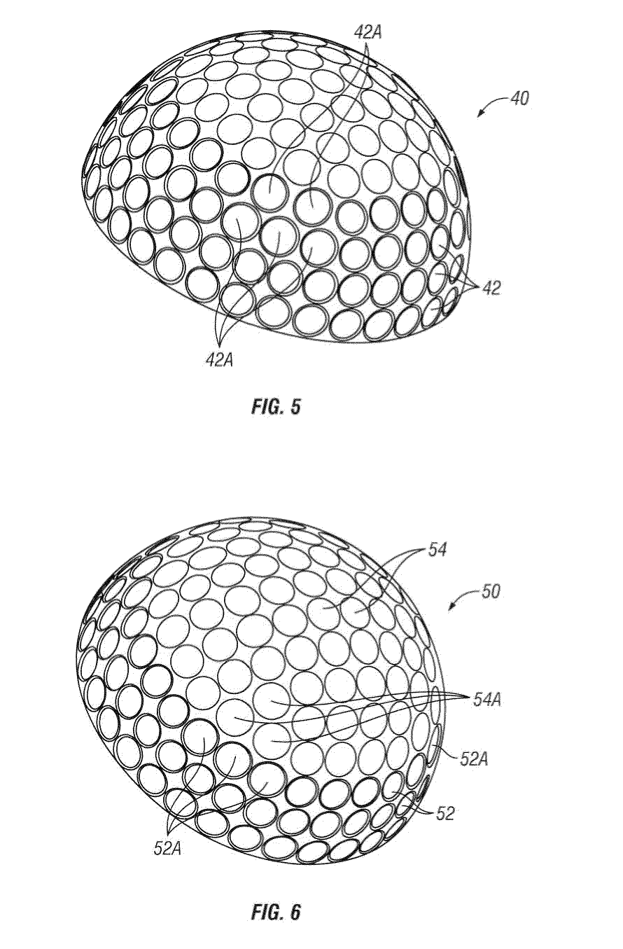

FIG. 5 is perspective view similar to FIG. 1 but illustrating a modified dimple pattern with some rows of dimples around the equator removed;

FIG. 9 is a diagram illustrating the relationship between the chord depth of a truncated and a spherical dimple in the embodiments of FIGS. 1 to 7;

FIG. 10 is a graph illustrating the average carry and total dispersion versus the moment of inertia (MOI) difference between the minimum and maximum orientations for balls having each of the dimple patterns of FIGS. 1 to 7, and a modified version of the pattern of FIG. 1, compared with a ball having the dimple pattern of the known non-conforming Polara™ ball and the known TopFlite XL straight ball;

FIG. 11 is a graph illustrating the average carry and total distance versus MOI difference between the minimum and maximum orientations for the same balls as in FIG. 10;

FIG. 12 is a graph illustrating the top view of the flights of the golf balls of FIGS. 1, 2 and 3 and several known balls in a robot slice shot test, illustrating the dispersion of each ball with distance downrange;

FIG. 13 is a side view of the flight paths of FIG. 12, illustrating the maximum height of each ball;

FIGS. 14 to 17 illustrate the lift and drag coefficients versus Reynolds number for the same balls which are the subject of the graphs in FIGS. 12 and 13, at spin rates of 3,500 and 4,500, respectively, for different ball orientations; and

FIG. 18 is a diagram illustrating a golf ball configured in accordance with another embodiment.

### DETAILED DESCRIPTION

After reading this description it will become apparent to one skilled in the art how to implement the embodiments in various alternative implementations and alternative applications. Further; although various embodiments will be described herein, it is understood that these embodiments are presented by way of example only, and not limitation. As such, this detailed description of various alternative embodiments should not be construed to limit the scope or breadth of the appended claims.

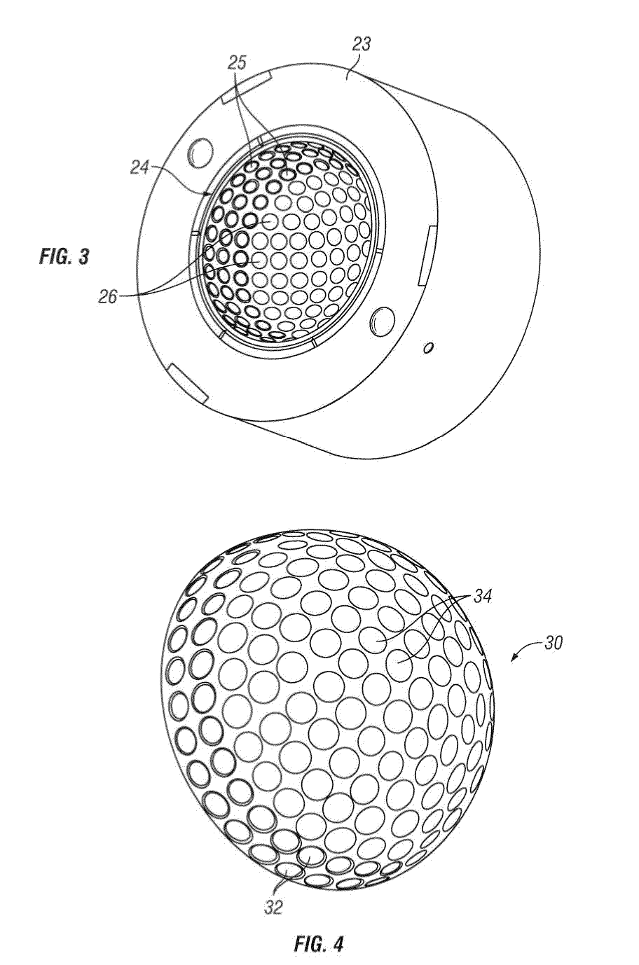

FIGS. 1 to 8 illustrate several embodiments of non-conforming or non-symmetrical balls having different dimple patterns, as described in more detail below. In each case, one hemisphere of the ball (or of a mold cavity for making the ball in FIG. 3) cut in half through the equator is illustrated, with the other hemisphere having an identical dimple pattern to the illustrated hemisphere. In each embodiment, the dimples are of greater total volume in a first area or areas, and of less volume in a second area. In the illustrated embodiment, the first areas, which are of greater dimple volume, are in the polar regions of the ball while the second area is a band around the equator, designed to produce a preferred spin axis through the poles of the ball, due to the larger weight around the equatorial band, which has a lower dimple volume, i.e. lower volume of material removed from the ball surface. Other embodiments may have the reduced volume dimple regions located in different regions of the ball, as long as the dimple pattern is designed to impart a preferred spin axis to the ball, such that hook and slice dispersion is reduced when a ball is struck with the spin axis in a horizontal orientation (PH when the spin axis extends through the poles).

In the embodiments of FIGS. 1-8, the preferred spin axis goes through the poles of the ball. It will be understood that the design of FIGS. 1-8 can be said to then have a gyroscopic center plane orthogonal to the preferred spin axis, i.e., that goes through and is parallel with the equatorial band. Thus, the designs of FIGS. 1-8 can be said to have a region of lower volume dimples around the gyroscopic center plane. It should also be recognized that in these embodiments, the gyroscopic center plane does not go through all regions, i.e., it does not go through the regions with greater dimple volume.

It should also be understood that the terms equator or equatorial region and poles can be defined with respect to the gyroscopic center plane. In other words, the equator is in the gyroscopic center plane and the preferred spin axis goes through the poles.

In fact it has been determined that making dimples more shallow within the region inside the approximately 45 degree point 1803 on the circumference of the ball 10 with respect to the gyroscopic center plane 1801, as illustrated in FIG. 18, further increases the MOI difference between the ball rotating in the PH and pole-over-pole (POP) orientations as described below. Conversely, making dimples deeper inside of the approximately 45 degree point 1803 decreases the MOI difference between the ball rotating in the PH and pole-over-pole (POP) orientations. For reference, the preferred spin axis 1802 is also illustrated in FIG. 18.

FIG. 1 illustrates one hemisphere of a first embodiment of a non-conforming or non-symmetrical golf ball 10 having a first dimple pattern, hereinafter referred to as dimple pattern design 28-1, or “28-1 ball”. The dimple pattern is designed to create a difference in moment of inertia (MOI) between poles horizontal (PH) and other orientations. The dimple pattern of the 28-1 ball has three rows of shallow truncated dimples 12, around the ball's equator, in each hemisphere, so the ball has a total of six rows of shallow truncated dimples. The polar region has a first set of generally larger, deep spherical dimples 14 and a second set of generally smaller, deep spherical dimples 15, which are dispersed between the larger spherical dimples 14. There are no smaller dimples 15 in the two rows of the larger spherical dimples closest to the band of shallow truncated dimples 12. This arrangement removes more weight from the polar areas of the ball and thus further increases the MOI difference between the ball rotating in the PH and pole-over-pole (POP) orientations.

Shown in Table 1 below are the dimple radius, depth and dimple location information for making a hemispherical injection molding cavity to produce the dimple pattern 28-1 on one hemisphere of the ball, with the other injection molding cavity being identical. As illustrated in Table 1, the ball has a total of 410 dimples (205 in each hemisphere of the ball). The truncated dimples 12 are each of the same radius and truncated chord depth, while the larger and smaller spherical dimples are each of three different sizes (Smaller dimples 1, 2 and 3 and larger dimples 5, 6, 7 in Table 1). Table 1 illustrates the locations of the truncated dimples and each of the different size spherical dimples on one hemisphere of the ball.

TABLE 1
Dimple Pattern Design# = 28-1
Molding cavity internal diameter = 1.692″
Total number of dimples on ball = 410

| Dimple # 1 | | | Dimple # 2 | | | Dimple # 3 | | | Dimple # 4 | | |
|---|---|---|---|---|---|---|---|---|---|---|---|
| Type spherical | | | Type spherical | | | Type spherical | | | Type truncated | | |
| Radius 0.0300 | | | Radius 0.0350 | | | Radius 0.0400 | | | Radius 0.0670 | | |
| SCD 0.0080 | | | SCD 0.0080 | | | SCD 0.0080 | | | SCD 0.0121 | | |
| TCD — | | | TCD — | | | TCD — | | | TCD 0.0039 | | |
| # | Phi | Theta | # | Phi | Theta | # | Phi | Theta | # | Phi | Theta |
| 1 | 0 | 31.89226 | 1 | 0 | 15.8163 | 1 | 0 | 0 | 1 | 0 | 62.0690668 |
| 2 | 90 | 31.89226 | 2 | 17.723349 | 24.95272 | 2 | 45 | 11.141573 | 2 | 0 | 84.1 |
| 3 | 180 | 31.89226 | 3 | 25.269266 | 35.26266 | 3 | 45 | 22.380098 | 3 | 5.65 | 73.3833254 |
| 4 | 270 | 31.89226 | 4 | 64.730734 | 35.26266 | 4 | 45 | 33.669653 | 4 | 11.26 | 84.1 |
| | | | 5 | 72.276651 | 24.95272 | 5 | 135 | 11.141573 | 5 | 13.34 | 62.0690668 |
| | | | 6 | 90 | 15.8163 | 6 | 135 | 22.380098 | 6 | 16.83 | 73.3833254 |
| | | | 7 | 107.72335 | 24.95272 | 7 | 135 | 33.669653 | 7 | 22.66 | 84.1 |
| | | | 8 | 115.26927 | 35.26266 | 8 | 225 | 11.141573 | 8 | 26.32 | 62.8658456 |
| | | | 9 | 154.73073 | 35.26266 | 9 | 225 | 22.380098 | 9 | 27.98 | 73.3833254 |
| | | | 10 | 162.27665 | 24.95272 | 10 | 225 | 33.669653 | 10 | 33.82 | 84.1 |
| | | | 11 | 180 | 15.8163 | 11 | 315 | 11.141573 | 11 | 38.44 | 61.760315 |
| | | | 12 | 197.72335 | 24.95272 | 12 | 315 | 22.380098 | 12 | 39.02 | 73.3833254 |
| | | | 13 | 205.26927 | 35.26266 | 13 | 315 | 33.669653 | 13 | 45 | 84.1 |
| | | | 14 | 244.73073 | 35.26266 | | | | 14 | 50.98 | 73.3833254 |
| | | | 15 | 252.27665 | 24.95272 | | | | 15 | 51.56 | 61.760315 |
| | | | 16 | 270 | 15.8163 | | | | 16 | 56.18 | 84.1 |
| | | | 17 | 287.72335 | 24.95272 | | | | 17 | 62.02 | 73.3833254 |
| | | | 18 | 295.26927 | 35.26266 | | | | 18 | 63.68 | 62.8658456 |
| | | | 19 | 334.73073 | 35.26266 | | | | 19 | 67.34 | 84.1 |
| | | | 20 | 342.27665 | 24.95272 | | | | 20 | 73.17 | 73.3833254 |
| | | | | | | | | | 21 | 76.66 | 62.0690668 |
| | | | | | | | | | 22 | 78.74 | 84.1 |
| | | | | | | | | | 23 | 84.35 | 73.3833254 |
| | | | | | | | | | 24 | 90 | 62.0690668 |
| | | | | | | | | | 25 | 90 | 84.1 |
| | | | | | | | | | 26 | 95.65 | 73.3833254 |
| | | | | | | | | | 27 | 101.26 | 84.1 |
| | | | | | | | | | 28 | 103.34 | 62.0690668 |
| | | | | | | | | | 29 | 106.83 | 73.3833254 |
| | | | | | | | | | 30 | 112.66 | 84.1 |
| | | | | | | | | | 31 | 116.32 | 62.8658456 |
| | | | | | | | | | 32 | 117.98 | 73.3833254 |
| | | | | | | | | | 33 | 123.82 | 84.1 |
| | | | | | | | | | 34 | 128.44 | 61.760315 |
| | | | | | | | | | 35 | 129.02 | 73.3833254 |
| | | | | | | | | | 36 | 135 | 84.1 |
| | | | | | | | | | 37 | 140.98 | 73.3833254 |
| | | | | | | | | | 38 | 141.56 | 61.760315 |
| | | | | | | | | | 39 | 146.18 | 84.1 |
| | | | | | | | | | 40 | 152.02 | 73.3833254 |
| | | | | | | | | | 41 | 153.68 | 62.8658456 |
| | | | | | | | | | 42 | 157.34 | 84.1 |
| | | | | | | | | | 43 | 163.17 | 73.3833254 |
| | | | | | | | | | 44 | 166.66 | 62.0690668 |
| | | | | | | | | | 45 | 168.74 | 84.1 |
| | | | | | | | | | 46 | 174.35 | 73.3833254 |
| | | | | | | | | | 47 | 180 | 62.0690668 |
| | | | | | | | | | 48 | 180 | 84.1 |
| | | | | | | | | | 49 | 185.65 | 73.3833254 |
| | | | | | | | | | 50 | 191.26 | 84.1 |
| | | | | | | | | | 51 | 193.34 | 62.0690668 |
| | | | | | | | | | 52 | 196.83 | 73.3833254 |
| | | | | | | | | | 53 | 202.66 | 84.1 |
| | | | | | | | | | 54 | 206.32 | 62.8658456 |
| | | | | | | | | | 55 | 207.98 | 73.3833254 |
| | | | | | | | | | 56 | 213.82 | 84.1 |
| | | | | | | | | | 57 | 218.44 | 61.760315 |
| | | | | | | | | | 58 | 219.02 | 73.3833254 |
| | | | | | | | | | 59 | 225 | 84.1 |
| | | | | | | | | | 60 | 230.98 | 73.3833254 |
| | | | | | | | | | 61 | 231.56 | 61.760315 |
| | | | | | | | | | 62 | 236.18 | 84.1 |
| | | | | | | | | | 63 | 242.02 | 73.3833254 |
| | | | | | | | | | 64 | 243.68 | 62.8658456 |
| | | | | | | | | | 65 | 247.34 | 84.1 |
| | | | | | | | | | 66 | 253.17 | 73.3833254 |
| | | | | | | | | | 67 | 256.66 | 62.0690668 |
| | | | | | | | | | 68 | 258.74 | 84.1 |
| | | | | | | | | | 69 | 264.35 | 73.3833254 |
| | | | | | | | | | 70 | 270 | 62.0690668 |
| | | | | | | | | | 71 | 270 | 84.1 |
| | | | | | | | | | 72 | 275.65 | 73.3833254 |
| | | | | | | | | | 73 | 281.26 | 84.1 |
| | | | | | | | | | 74 | 283.34 | 62.0690668 |
| | | | | | | | | | 75 | 286.83 | 73.3833254 |
| | | | | | | | | | 76 | 292.66 | 84.1 |
| | | | | | | | | | 77 | 296.32 | 62.8658456 |
| | | | | | | | | | 78 | 297.98 | 73.3833254 |
| | | | | | | | | | 79 | 303.82 | 84.1 |
| | | | | | | | | | 80 | 308.44 | 61.760315 |
| | | | | | | | | | 81 | 309.02 | 73.3833254 |
| | | | | | | | | | 82 | 315 | 84.1 |
| | | | | | | | | | 83 | 320.98 | 73.3833254 |
| | | | | | | | | | 84 | 321.56 | 61.760315 |
| | | | | | | | | | 85 | 326.18 | 84.1 |
| | | | | | | | | | 86 | 332.02 | 73.3833254 |
| | | | | | | | | | 87 | 333.68 | 62.8658456 |
| | | | | | | | | | 88 | 337.34 | 84.1 |
| | | | | | | | | | 89 | 343.17 | 73.3833254 |
| | | | | | | | | | 90 | 346.66 | 62.0690668 |
| | | | | | | | | | 91 | 348.74 | 84.1 |
| | | | | | | | | | 92 | 354.35 | 73.3833254 |

| Dimple # 5 | | | Dimple # 6 | | | Dimple # 7 | | |
|---|---|---|---|---|---|---|---|---|
| Type spherical | | | Type spherical | | | Type spherical | | |
| Radius 0.0670 | | | Radius 0.0725 | | | Radius 0.0750 | | |
| SCD 0.0121 | | | SCD 0.0121 | | | SCD 0.0121 | | |
| TCD — | | | TCD — | | | TCD — | | |
| # | Phi | Theta | # | Phi | Theta | # | Phi | Theta |
| 1 | 12.73 | 32.21974 | 1 | 0 | 7.87815 | 1 | 8.38 | 51.07352 |
| 2 | 77.27 | 32.21974 | 2 | 0 | 23.47509 | 2 | 23.8 | 52.408124 |
| 3 | 102.73 | 32.21974 | 3 | 0 | 40.93451 | 3 | 66.2 | 52.408124 |
| 4 | 167.27 | 32.21974 | 4 | 19.68 | 42.05 | 4 | 81.62 | 51.07352 |
| 5 | 192.73 | 32.21974 | 5 | 25.81 | 17.61877 | 5 | 98.38 | 51.07352 |
| 6 | 257.27 | 32.21974 | 6 | 32.87 | 28.60436 | 6 | 113.8 | 52.408124 |
| 7 | 282.73 | 32.21974 | 7 | 35.9 | 39.62978 | 7 | 156.2 | 52.408124 |
| 8 | 347.27 | 32.21974 | 8 | 37.5 | 50.62533 | 8 | 171.62 | 51.07352 |
| | | | 9 | 52.5 | 50.62533 | 9 | 188.38 | 51.07352 |
| | | | 10 | 54.1 | 39.62978 | 10 | 203.8 | 52.408124 |
| | | | 11 | 57.13 | 28.60436 | 11 | 246.2 | 52.408124 |
| | | | 12 | 64.19 | 17.61877 | 12 | 261.62 | 51.07352 |
| | | | 13 | 70.32 | 42.05 | 13 | 278.38 | 51.07352 |
| | | | 14 | 90 | 7.87815 | 14 | 293.8 | 52.408124 |
| | | | 15 | 90 | 23.47509 | 15 | 336.2 | 52.408124 |
| | | | 16 | 90 | 40.93451 | 16 | 351.62 | 51.07352 |
| | | | 17 | 109.68 | 42.05 | | | |
| | | | 18 | 115.81 | 17.61877 | | | |
| | | | 19 | 122.87 | 28.60436 | | | |
| | | | 20 | 125.9 | 39.62978 | | | |
| | | | 21 | 127.5 | 50.62533 | | | |
| | | | 22 | 142.5 | 50.62533 | | | |
| | | | 23 | 144.1 | 39.62978 | | | |
| | | | 24 | 147.13 | 28.60436 | | | |
| | | | 25 | 154.19 | 17.61877 | | | |
| | | | 26 | 160.32 | 42.05 | | | |
| | | | 27 | 180 | 7.87815 | | | |
| | | | 28 | 180 | 23.47509 | | | |
| | | | 29 | 180 | 40.93451 | | | |
| | | | 30 | 199.68 | 42.05 | | | |
| | | | 31 | 205.81 | 17.61877 | | | |
| | | | 32 | 212.87 | 28.60436 | | | |
| | | | 33 | 215.9 | 39.62978 | | | |
| | | | 34 | 217.5 | 50.62533 | | | |
| | | | 35 | 232.5 | 50.62533 | | | |
| | | | 36 | 234.1 | 39.62978 | | | |
| | | | 37 | 237.13 | 28.60436 | | | |
| | | | 38 | 244.19 | 17.61877 | | | |
| | | | 39 | 250.32 | 42.05 | | | |
| | | | 40 | 270 | 7.87815 | | | |
| | | | 41 | 270 | 23.47509 | | | |
| | | | 42 | 270 | 40.93451 | | | |
| | | | 43 | 289.68 | 42.05 | | | |
| | | | 44 | 295.81 | 17.61877 | | | |
| | | | 45 | 302.87 | 28.60436 | | | |
| | | | 46 | 305.9 | 39.62978 | | | |
| | | | 47 | 307.5 | 50.62533 | | | |
| | | | 48 | 322.5 | 50.62533 | | | |
| | | | 49 | 324.1 | 39.62978 | | | |
| | | | 50 | 327.13 | 28.60436 | | | |
| | | | 51 | 334.19 | 17.61877 | | | |
| | | | 52 | 340.32 | 42.05 | | | |

As seen in FIG. 1 and Table 1, the first, larger set of spherical dimples 14 include dimples of three different radii, specifically 8 dimples of a first, smaller radius (0.067 inches), 52 dimples of a second, larger radius (0.0725 inches) and 16 dimples of a third, largest radius (0.075 inches). Thus, there are a total of 76 larger spherical dimples 14 in each hemisphere of ball 10. The second, smaller set of spherical dimples, which are arranged between the larger dimples in a region closer to the pole, are also in three slightly different sizes from approximately 0.03 inches to approximately 0.04 inches, and one hemisphere of the ball includes 37 smaller spherical dimples. The truncated dimples are all of the same size and have a radius of 0.067 inches (the same as the smallest spherical dimples of the first set) and a truncated chord depth of 0.0039 inches. There are 92 truncated dimples in one hemisphere of the ball. All of the spherical dimples 14 have the same spherical chord depth of 0.0121 inches, while the smaller spherical dimples 15 have a spherical chord depth of 0.008 inches. Thus, the truncated chord depth of the truncated dimples is significantly less than the spherical chord depth of the spherical dimples, and is about one third of the depth of the larger spherical dimples 14, and about one half the depth of the smaller dimples 15.

With this dimple arrangement, significantly more material is removed from the polar regions of the ball to create the larger, deeper spherical dimples, and less material is removed to create the band of shallower, truncated dimples around the equator. In testing described in more detail below, the 28-1 dimple pattern of FIG. 1 and Table 1 was found to have a preferred spin axis through the poles, as expected, so that dispersion is reduced if the ball is placed on the tee in a poles horizontal (PH) orientation. This ball was also found to generate relatively low lift when the ball spins about the preferred spin axis.

FIG. 2 illustrates one hemisphere of a second embodiment of a ball 16 having a different dimple pattern, hereinafter referred to as 25-1, which has three rows of shallow truncated dimples 18 around the ball's equator in each hemisphere and deep spherical dimples 20 in the polar region of the ball. The deep dimples closest to the pole also have smaller dimples 22 dispersed between the larger dimples. The overall dimple pattern in FIG. 2 is similar to that of FIG. 1, but the total number of dimples is less (386). Ball 16 has the same number of truncated dimples as ball 10, but has fewer spherical dimples of less volume than the spherical dimples of ball 10 (see Table 2 below). Each hemisphere of ball 16 has 92 truncated dimples and 101 spherical dimples 20 and 22. The main difference between patterns 28-1 and 25-1 is that the 28-1 ball of FIG. 1 has more weight removed from the polar regions because the small dimples between deep dimples are larger in number and volume for dimple pattern 28-1 compared to 25-1, and the larger, deeper dimples are also of generally larger size for dimple pattern 28-1 than the larger spherical dimples in the 25-1 dimple pattern. The larger spherical dimples 20 in the ball 16 are all of the same size, which is equal to the smallest large dimple size in the 28-1 ball. The truncated dimples in FIG. 2 are of the same size as the truncated dimples in FIG. 1, and the truncated dimple radius is the same as the radius of the larger spherical dimples 20.

Shown in Table 2 are the dimple radius, depth and dimple location information for making an injection molding cavity to produce the dimple pattern 25-1 of FIG. 2.

TABLE 2
Dimple Pattern Design# = 25-1
Molding cavity internal diameter = 1.694″
Total number of dimples on ball = 386

| Dimple # 1 | | | Dimple # 2 | | | Dimple # 3 | | | Dimple # 4 | | |
|---|---|---|---|---|---|---|---|---|---|---|---|
| Type spherical | | | Type spherical | | | Type truncated | | | Type spherical | | |
| Radius 0.0300 | | | Radius 0.0350 | | | Radius 0.0670 | | | Radius 0.0670 | | |
| SCD 0.0080 | | | SCD 0.0080 | | | SCD 0.0121 | | | SCD 0.0121 | | |
| TCD — | | | TCD — | | | TCD 0.0039 | | | TCD — | | |
| # | Phi | Theta | # | Phi | Theta | # | Phi | Theta | # | Phi | Theta |
| 1 | 0 | 32.02119 | 1 | 0 | 0 | 1 | 0 | 62.32 | 1 | 0 | 7.91 |
| 2 | 90 | 32.02119 | 2 | 0 | 15.88024 | 2 | 0 | 84.44 | 2 | 0 | 23.57 |
| 3 | 180 | 32.02119 | 3 | 17.72335 | 25.0536 | 3 | 5.65 | 73.68 | 3 | 0 | 41.1 |
| 4 | 270 | 32.02119 | 4 | 45 | 11.18662 | 4 | 11.26 | 84.44 | 4 | 8.38 | 51.28 |
| | | | 5 | 45 | 22.47058 | 5 | 13.34 | 62.32 | 5 | 12.73 | 32.35 |
| | | | 6 | 72.27665 | 25.0536 | 6 | 16.83 | 73.68 | 6 | 19.68 | 42.22 |
| | | | 7 | 90 | 15.88024 | 7 | 22.66 | 84.44 | 7 | 23.8 | 52.62 |
| | | | 8 | 107.7233 | 25.0536 | 8 | 26.32 | 63.12 | 8 | 25.81 | 17.69 |
| | | | 9 | 135 | 11.18662 | 9 | 27.98 | 73.68 | 9 | 32.87 | 28.72 |
| | | | 10 | 135 | 22.47058 | 10 | 33.82 | 84.44 | 10 | 35.9 | 39.79 |
| | | | 11 | 162.2767 | 25.0536 | 11 | 38.44 | 62.01 | 11 | 37.5 | 50.83 |
| | | | 12 | 180 | 15.88024 | 12 | 39.02 | 73.68 | 12 | 52.5 | 50.83 |
| | | | 13 | 197.7233 | 25.0536 | 13 | 45 | 84.44 | 13 | 54.1 | 39.79 |
| | | | 14 | 225 | 11.18662 | 14 | 50.98 | 73.68 | 14 | 57.13 | 28.72 |
| | | | 15 | 225 | 22.47058 | 15 | 51.56 | 62.01 | 15 | 64.19 | 17.69 |
| | | | 16 | 252.2767 | 25.0536 | 16 | 56.18 | 84.44 | 16 | 66.2 | 52.62 |
| | | | 17 | 270 | 15.88024 | 17 | 62.02 | 73.68 | 17 | 70.32 | 42.22 |
| | | | 18 | 287.7233 | 25.0536 | 18 | 63.68 | 63.12 | 18 | 77.27 | 32.35 |
| | | | 19 | 315 | 11.18662 | 19 | 67.58 | 84.44 | 19 | 81.62 | 51.28 |
| | | | 20 | 315 | 22.47058 | 20 | 73.17 | 73.68 | 20 | 90 | 7.91 |
| | | | 21 | 342.2767 | 25.0536 | 21 | 76.66 | 62.32 | 21 | 90 | 23.57 |
| | | | | | | 22 | 78.84 | 84.44 | 22 | 90 | 41.1 |
| | | | | | | 23 | 84.35 | 73.68 | 23 | 98.38 | 51.28 |
| | | | | | | 24 | 90 | 62.32 | 24 | 102.73 | 32.35 |
| | | | | | | 25 | 90 | 84.44 | 25 | 109.68 | 42.22 |
| | | | | | | 26 | 95.65 | 73.68 | 26 | 113.8 | 52.62 |
| | | | | | | 27 | 101.26 | 84.44 | 27 | 115.81 | 17.69 |
| | | | | | | 28 | 103.34 | 62.32 | 28 | 122.87 | 28.72 |
| | | | | | | 29 | 106.83 | 73.68 | 29 | 125.9 | 39.79 |
| | | | | | | 30 | 112.66 | 84.44 | 30 | 127.5 | 50.83 |
| | | | | | | 31 | 116.32 | 63.12 | 31 | 142.5 | 50.83 |
| | | | | | | 32 | 117.98 | 73.68 | 32 | 144.1 | 39.79 |
| | | | | | | 33 | 123.82 | 84.44 | 33 | 147.13 | 28.72 |
| | | | | | | 34 | 128.44 | 62.01 | 34 | 154.19 | 17.69 |
| | | | | | | 35 | 129.02 | 73.68 | 35 | 156.2 | 52.62 |
| | | | | | | 36 | 135 | 84.44 | 36 | 160.32 | 42.22 |
| | | | | | | 37 | 140.98 | 73.68 | 37 | 167.27 | 32.35 |
| | | | | | | 38 | 141.56 | 62.01 | 38 | 171.62 | 51.28 |
| | | | | | | 39 | 146.18 | 84.44 | 39 | 180 | 7.91 |
| | | | | | | 40 | 152.02 | 73.68 | 40 | 180 | 23.57 |
| | | | | | | 41 | 153.68 | 63.12 | 41 | 180 | 41.1 |
| | | | | | | 42 | 157.58 | 84.44 | 42 | 188.38 | 51.28 |
| | | | | | | 43 | 163.17 | 73.68 | 43 | 192.73 | 32.35 |
| | | | | | | 44 | 166.66 | 62.32 | 44 | 199.68 | 42.22 |
| | | | | | | 45 | 168.84 | 84.44 | 45 | 203.8 | 52.62 |
| | | | | | | 46 | 174.35 | 73.68 | 46 | 205.81 | 17.69 |
| | | | | | | 47 | 180 | 84.44 | 47 | 212.87 | 28.72 |
| | | | | | | 48 | 180 | 62.32 | 48 | 215.9 | 39.79 |
| | | | | | | 49 | 185.65 | 73.68 | 49 | 217.5 | 50.83 |
| | | | | | | 50 | 191.26 | 84.44 | 50 | 232.5 | 50.83 |
| | | | | | | 51 | 193.34 | 62.32 | 51 | 234.1 | 39.79 |
| | | | | | | 52 | 196.83 | 73.68 | 52 | 237.13 | 28.72 |
| | | | | | | 53 | 202.66 | 84.44 | 53 | 244.19 | 17.69 |
| | | | | | | 54 | 206.32 | 63.12 | 54 | 246.2 | 52.62 |
| | | | | | | 55 | 207.98 | 73.68 | 55 | 250.32 | 42.22 |
| | | | | | | 56 | 213.82 | 84.44 | 56 | 257.27 | 32.35 |
| | | | | | | 57 | 218.44 | 62.01 | 57 | 261.62 | 51.28 |
| | | | | | | 58 | 219.02 | 73.68 | 58 | 270 | 7.91 |
| | | | | | | 59 | 225 | 84.44 | 59 | 270 | 23.57 |
| | | | | | | 60 | 230.98 | 73.68 | 60 | 270 | 41.1 |
| | | | | | | 61 | 231.56 | 62.01 | 61 | 278.38 | 51.28 |
| | | | | | | 62 | 236.18 | 84.44 | 62 | 282.73 | 32.35 |
| | | | | | | 63 | 242.02 | 73.68 | 63 | 289.68 | 42.22 |
| | | | | | | 64 | 243.68 | 63.12 | 64 | 293.8 | 52.62 |
| | | | | | | 65 | 247.58 | 84.44 | 65 | 295.81 | 17.69 |
| | | | | | | 66 | 253.17 | 73.68 | 66 | 302.87 | 28.72 |
| | | | | | | 67 | 256.66 | 62.32 | 67 | 305.9 | 39.79 |
| | | | | | | 68 | 258.84 | 84.44 | 68 | 307.5 | 50.83 |
| | | | | | | 69 | 264.35 | 73.68 | 69 | 322.5 | 50.83 |
| | | | | | | 70 | 270 | 62.32 | 70 | 324.1 | 39.79 |
| | | | | | | 71 | 270 | 84.44 | 71 | 327.13 | 28.72 |
| | | | | | | 72 | 275.65 | 73.68 | 72 | 334.19 | 17.69 |
| | | | | | | 73 | 281.26 | 84.44 | 73 | 336.2 | 52.62 |
| | | | | | | 74 | 283.34 | 62.32 | 74 | 340.32 | 42.22 |
| | | | | | | 75 | 286.83 | 73.68 | 75 | 347.27 | 32.35 |
| | | | | | | 76 | 292.66 | 84.44 | 76 | 351.62 | 51.28 |
| | | | | | | 77 | 296.32 | 63.12 | | | |
| | | | | | | 78 | 297.98 | 73.68 | | | |
| | | | | | | 79 | 303.82 | 84.44 | | | |
| | | | | | | 80 | 308.44 | 62.01 | | | |
| | | | | | | 81 | 309.02 | 73.68 | | | |
| | | | | | | 82 | 315 | 84.44 | | | |
| | | | | | | 83 | 320.98 | 73.68 | | | |
| | | | | | | 84 | 321.56 | 62.01 | | | |
| | | | | | | 85 | 326.18 | 84.44 | | | |
| | | | | | | 86 | 332.02 | 73.68 | | | |
| | | | | | | 87 | 333.68 | 63.12 | | | |
| | | | | | | 88 | 337.58 | 84.44 | | | |
| | | | | | | 89 | 343.17 | 73.68 | | | |
| | | | | | | 90 | 346.66 | 62.32 | | | |
| | | | | | | 91 | 348.84 | 84.44 | | | |
| | | | | | | 92 | 354.35 | 73.68 | | | |

As indicated in Table 2, ball 25-1 has only two different size smaller spherical dimples 22 in the polar region (dimples 1 and 2 which are the same size as dimples 1 and 2 of the 28-1 ball), and only one size larger spherical dimple 20, i.e. dimple 4 which is the same size as dimple 5 of the 28-1 ball. Thus, the 28-1 ball has some spherical dimples, specifically dimples 6 and 7 in Table 1, which are of larger diameter than any of the spherical dimples 20 of the 25-1 ball.

FIG. 3 illustrates a mold 23 having one hemisphere of a compression molding cavity 24 designed for making a third embodiment of a ball having a different dimple pattern, identified as dimple pattern or ball 2-9. The cavity 24 has three rows of raised, flattened bumps 25 designed to form three rows of shallow, truncated dimples around the ball's equator, and a polar region having raised, generally hemispherical bumps 26 designed to form deep, spherical dimples in the polar region of a ball. The resultant dimple pattern has three rows of shallow truncated dimples around the ball's equator and deep spherical dimples 2 in the polar region of the ball in each hemisphere of the ball. As illustrated in FIG. 3 and shown in Table 3 below, there is only one size of truncated dimple and one size of spherical dimple in the 2-9 dimple pattern. The truncated dimples are identified as dimple #1 in Table 3 below, and the spherical dimples are identified as dimple #2 in Table 3. The 2-9 ball has a total of 336 dimples, with 92 truncated dimples of the same size as the truncated dimples of the 28-1 and 25-1 balls, and 76 deep spherical dimples which are all the same size as the large spherical dimples of the 25-1 ball. Thus, about the same dimple volume is removed around the equator in balls 28-1, 25-1 and 2-9, but more dimple volume is removed in the polar region in ball 28-1 than in balls 25-1 and 2-9, and ball 2-9 has less volume removed in the polar regions than balls 28-1 and 25-1.

It will be understood that a similar type of mold, or set of molds, is used for all of the embodiments described herein, and that mold 23 is shown by way of example only.

TABLE 3
Dimple Pattern Design# 2-9
Molding cavity internal diameter = 1.694″
Total number of dimples on ball = 336

| Dimple # 1 | | | Dimple # 2 | | |
|---|---|---|---|---|---|
| Type truncated | | | Type spherical | | |
| Radius 0.0670 | | | Radius 0.0670 | | |
| SCD 0.0121 | | | SCD 0.0121 | | |
| TCD 0.0039 | | | TCD — | | |
| # | Phi | Theta | # | Phi | Theta |
| 1 | 0 | 62.32 | 1 | 0 | 7.91 |
| 2 | 5.58 | 84.44 | 2 | 0 | 23.57 |
| 3 | 5.65 | 73.68 | 3 | 0 | 41.1 |
| 4 | 13.34 | 62.32 | 4 | 8.38 | 51.28 |
| 5 | 16.83 | 73.68 | 5 | 12.73 | 32.35 |
| 6 | 16.84 | 84.44 | 6 | 19.68 | 42.22 |
| 7 | 26.32 | 63.12 | 7 | 23.8 | 52.62 |
| 8 | 27.98 | 73.68 | 8 | 25.81 | 17.69 |
| 9 | 28.24 | 84.44 | 9 | 32.87 | 28.72 |
| 10 | 38.44 | 62.01 | 10 | 35.9 | 39.79 |
| 11 | 39.02 | 73.68 | 11 | 37.5 | 50.83 |
| 12 | 39.4 | 84.44 | 12 | 52.5 | 50.83 |
| 13 | 50.6 | 84.44 | 13 | 54.1 | 39.79 |
| 14 | 50.98 | 73.68 | 14 | 57.13 | 28.72 |
| 15 | 51.56 | 62.01 | 15 | 64.19 | 17.69 |
| 16 | 61.76 | 84.44 | 16 | 66.2 | 52.62 |
| 17 | 62.02 | 73.68 | 17 | 70.32 | 42.22 |
| 18 | 63.68 | 63.12 | 18 | 77.27 | 32.35 |
| 19 | 73.16 | 84.44 | 19 | 81.62 | 51.28 |
| 20 | 73.17 | 73.68 | 20 | 90 | 7.91 |
| 21 | 76.66 | 62.32 | 21 | 90 | 23.57 |
| 22 | 84.35 | 73.68 | 22 | 90 | 41.1 |
| 23 | 84.42 | 84.44 | 23 | 98.38 | 51.28 |
| 24 | 90 | 62.32 | 24 | 102.73 | 32.35 |
| 25 | 95.58 | 84.44 | 25 | 109.68 | 42.22 |
| 26 | 95.65 | 73.68 | 26 | 113.8 | 52.62 |
| 27 | 103.34 | 62.32 | 27 | 115.81 | 17.69 |
| 28 | 106.83 | 73.68 | 28 | 122.87 | 28.72 |
| 29 | 106.84 | 84.44 | 29 | 125.9 | 39.79 |
| 30 | 116.32 | 63.12 | 30 | 127.5 | 50.83 |
| 31 | 117.98 | 73.68 | 31 | 142.5 | 50.83 |
| 32 | 118.24 | 84.44 | 32 | 144.1 | 39.79 |
| 33 | 128.44 | 62.01 | 33 | 147.13 | 28.72 |
| 34 | 129.02 | 73.68 | 34 | 154.19 | 17.69 |
| 35 | 129.4 | 84.44 | 35 | 156.2 | 52.62 |
| 36 | 140.6 | 84.44 | 36 | 160.32 | 42.22 |
| 37 | 140.98 | 73.68 | 37 | 167.27 | 32.35 |
| 38 | 141.56 | 62.01 | 38 | 171.62 | 51.28 |
| 39 | 151.76 | 84.44 | 39 | 180 | 7.91 |
| 40 | 152.02 | 73.68 | 40 | 180 | 23.57 |
| 41 | 153.68 | 63.12 | 41 | 180 | 41.1 |
| 42 | 163.16 | 84.44 | 42 | 188.38 | 51.28 |
| 43 | 163.17 | 73.68 | 43 | 192.73 | 32.35 |
| 44 | 166.66 | 62.32 | 44 | 199.68 | 42.22 |
| 45 | 174.35 | 73.68 | 45 | 203.8 | 52.62 |
| 46 | 174.42 | 84.44 | 46 | 205.81 | 17.69 |
| 47 | 180 | 62.32 | 47 | 212.87 | 28.72 |
| 48 | 185.58 | 84.44 | 48 | 215.9 | 39.79 |
| 49 | 185.65 | 73.68 | 49 | 217.5 | 50.83 |
| 50 | 193.34 | 62.32 | 50 | 232.5 | 50.83 |
| 51 | 196.83 | 73.68 | 51 | 234.1 | 39.79 |
| 52 | 196.84 | 84.44 | 52 | 237.13 | 28.72 |
| 53 | 206.32 | 63.12 | 53 | 244.19 | 17.69 |
| 54 | 207.98 | 73.68 | 54 | 246.2 | 52.62 |
| 55 | 208.24 | 84.44 | 55 | 250.32 | 42.22 |
| 56 | 218.44 | 62.01 | 56 | 257.27 | 32.35 |
| 57 | 219.02 | 73.68 | 57 | 261.62 | 51.28 |
| 58 | 219.4 | 84.44 | 58 | 270 | 7.91 |
| 59 | 230.6 | 84.44 | 59 | 270 | 23.57 |
| 60 | 230.98 | 73.68 | 60 | 270 | 41.1 |
| 61 | 231.56 | 62.01 | 61 | 278.38 | 51.28 |
| 62 | 241.76 | 84.44 | 62 | 282.73 | 32.35 |
| 63 | 242.02 | 73.68 | 63 | 289.68 | 42.22 |
| 64 | 243.68 | 63.12 | 64 | 293.8 | 52.62 |
| 65 | 253.16 | 84.44 | 65 | 295.81 | 17.69 |
| 66 | 253.17 | 73.68 | 66 | 302.87 | 28.72 |
| 67 | 256.66 | 62.32 | 67 | 305.9 | 39.79 |
| 68 | 264.35 | 73.68 | 68 | 307.5 | 50.83 |
| 69 | 264.42 | 84.44 | 69 | 322.5 | 50.83 |
| 70 | 270 | 62.32 | 70 | 324.1 | 39.79 |
| 71 | 275.58 | 84.44 | 71 | 327.13 | 28.72 |
| 72 | 275.65 | 73.68 | 72 | 334.19 | 17.69 |
| 73 | 283.34 | 62.32 | 73 | 336.2 | 52.62 |
| 74 | 286.83 | 73.68 | 74 | 340.32 | 42.22 |
| 75 | 286.84 | 84.44 | 75 | 347.27 | 32.35 |
| 76 | 296.32 | 63.12 | 76 | 351.62 | 51.28 |
| 77 | 297.98 | 73.68 | | | |
| 78 | 298.24 | 84.44 | | | |
| 79 | 308.44 | 62.01 | | | |
| 80 | 309.02 | 73.68 | | | |
| 81 | 309.4 | 84.44 | | | |
| 82 | 320.6 | 84.44 | | | |
| 83 | 320.98 | 73.68 | | | |
| 84 | 321.56 | 62.01 | | | |
| 85 | 331.76 | 84.44 | | | |
| 86 | 332.02 | 73.68 | | | |
| 87 | 333.68 | 63.12 | | | |
| 88 | 343.16 | 84.44 | | | |
| 89 | 343.17 | 73.68 | | | |
| 90 | 346.66 | 62.32 | | | |
| 91 | 354.35 | 73.68 | | | |
| 92 | 354.42 | 84.44 | | | |

Table 4 below lists dimple shapes, dimensions, and coordinates or locations on a ball for a dimple pattern 28-2 which is very similar to the dimple pattern 28-1 and is therefore not shown separately in the drawings. The ball with dimple pattern 28-2 has three larger spherical dimples of different dimensions, numbered 5, 6 and 7 in Table 4, and three smaller spherical dimples of different dimensions, numbered 1, 2 and 3, and the dimensions of these dimples are identical to the corresponding dimples of the 28-1 ball in Table 1, as are the dimensions of truncated dimples numbered 4 in Table 4. The dimple pattern 28-2 is nearly identical to dimple pattern 28-1, except that the seam that separates the two hemispheres of the ball is wider in the 28-2 ball, and the coordinates of some of the dimples are slightly different, as can be determined by comparing Tables 1 and 4.

The dimple coordinates for pattern 28-2 are shown in table 4 below.

TABLE 4
Dimple Pattern Design# 28-2
Molding cavity internal diameter = 1.692″
Total number of dimples on ball = 410

| Dimple # 1 | | | Dimple # 2 | | | Dimple # 3 | | |
|---|---|---|---|---|---|---|---|---|
| Type spherical | | | Type spherical | | | Type spherical | | |
| Radius 0.0300 | | | Radius 0.0350 | | | Radius 0.0400 | | |
| SCD 0.0080 | | | SCD 0.0080 | | | SCD 0.0080 | | |
| TCD — | | | TCD — | | | TCD — | | |
| # | Phi | Theta | # | Phi | Theta | # | Phi | Theta |
| 1 | 0 | 31.8922591 | 1 | 0 | 15.816302 | 1 | 0 | 0 |
| 2 | 90 | 31.8922591 | 2 | 17.723349 | 24.952723 | 2 | 45 | 11.14157 |
| 3 | 180 | 31.8922591 | 3 | 25.269266 | 35.262662 | 3 | 45 | 22.3801 |
| 4 | 270 | 31.8922591 | 4 | 64.730734 | 35.262662 | 4 | 45 | 33.66965 |
| | | | 5 | 72.276651 | 24.952723 | 5 | 135 | 11.14157 |
| | | | 6 | 90 | 15.816302 | 6 | 135 | 22.3801 |
| | | | 7 | 107.72335 | 24.952723 | 7 | 135 | 33.66965 |
| | | | 8 | 115.26927 | 35.262662 | 8 | 225 | 11.14157 |
| | | | 9 | 154.73073 | 35.262662 | 9 | 225 | 22.3801 |
| | | | 10 | 162.27665 | 24.952723 | 10 | 225 | 33.66965 |
| | | | 11 | 180 | 15.816302 | 11 | 315 | 11.14157 |
| | | | 12 | 197.72335 | 24.952723 | 12 | 315 | 22.3801 |
| | | | 13 | 205.26927 | 35.262662 | 13 | 315 | 33.66965 |
| | | | 14 | 244.73073 | 35.262662 | | | |
| | | | 15 | 252.27665 | 24.952723 | | | |
| | | | 16 | 270 | 15.816302 | | | |
| | | | 17 | 287.72335 | 24.952723 | | | |
| | | | 18 | 295.26927 | 35.262662 | | | |
| | | | 19 | 334.73073 | 35.262662 | | | |
| | | | 20 | 342.27665 | 24.952723 | | | |

| Dimple # 5 | | | Dimple # 6 | | | Dimple # 7 | | |
|---|---|---|---|---|---|---|---|---|
| Type spherical | | | Type spherical | | | Type spherical | | |
| Radius 0.0670 | | | Radius 0.0725 | | | Radius 0.0750 | | |
| SCD 0.0121 | | | SCD 0.0121 | | | SCD 0.0121 | | |
| TCD — | | | TCD — | | | TCD — | | |
| # | Phi | Theta | # | Phi | Theta | # | Phi | Theta |
| 1 | 12.73 | 32.2197418 | 1 | 0 | 7.8781502 | 1 | 8.38 | 51.07352 |
| 2 | 77.27 | 32.2197418 | 2 | 0 | 23.475095 | 2 | 23.8 | 52.40812 |
| 3 | 102.73 | 32.2197418 | 3 | 0 | 40.93451 | 3 | 66.2 | 52.40812 |
| 4 | 167.27 | 32.2197418 | 4 | 19.68 | 42.05 | 4 | 81.62 | 51.07352 |
| 5 | 192.73 | 32.2197418 | 5 | 25.81 | 17.618771 | 5 | 98.38 | 51.07352 |
| 6 | 257.27 | 32.2197418 | 6 | 32.87 | 28.604358 | 6 | 113.8 | 52.40812 |
| 7 | 282.73 | 32.2197418 | 7 | 35.9 | 39.629784 | 7 | 156.2 | 52.40812 |
| 8 | 347.27 | 32.2197418 | 8 | 37.5 | 50.625332 | 8 | 171.62 | 51.07352 |
| | | | 9 | 52.5 | 50.625332 | 9 | 188.38 | 51.07352 |
| | | | 10 | 54.1 | 39.629784 | 10 | 203.8 | 52.40812 |
| | | | 11 | 57.13 | 28.604358 | 11 | 246.2 | 52.40812 |
| | | | 12 | 64.19 | 17.618771 | 12 | 261.62 | 51.07352 |
| | | | 13 | 70.32 | 42.05 | 13 | 278.38 | 51.07352 |
| | | | 14 | 90 | 7.8781502 | 14 | 293.8 | 52.40812 |
| | | | 15 | 90 | 23.475095 | 15 | 336.2 | 52.40812 |
| | | | 16 | 90 | 40.93451 | 16 | 351.62 | 51.07352 |

| Dimple # 4 | | | Dimple # 4 | | | Dimple # 6 | | |
|---|---|---|---|---|---|---|---|---|
| Type truncated | | | Type truncated | | | Type spherical | | |
| Radius 0.0670 | | | Radius 0.0670 | | | Radius 0.0725 | | |
| SCD 0.0121 | | | SCD 0.0121 | | | SCD 0.0121 | | |
| TCD 0.0039 | | | TCD 0.0039 | | | TCD — | | |
| # | Phi | Theta | # | Phi | Theta | # | Phi | Theta |
| 1 | 0 | 62.06907 | 45 | 44 | 106.0691 | 17 | 109.68 | 42.05 |
| 2 | 1 | 63.06907 | 46 | 45 | 107.0691 | 18 | 115.81 | 17.61877 |
| 3 | 2 | 64.06907 | 47 | 46 | 108.0691 | 19 | 122.87 | 28.60436 |
| 4 | 3 | 65.06907 | 48 | 47 | 109.0691 | 20 | 125.9 | 39.62978 |
| 5 | 4 | 66.06907 | 49 | 48 | 110.0691 | 21 | 127.5 | 50.62533 |
| 6 | 5 | 67.06907 | 50 | 49 | 111.0691 | 22 | 142.5 | 50.62533 |
| 7 | 6 | 68.06907 | 51 | 50 | 112.0691 | 23 | 144.1 | 39.62978 |
| 8 | 7 | 69.06907 | 52 | 51 | 113.0691 | 24 | 147.13 | 28.60436 |
| 9 | 8 | 70.06907 | 53 | 52 | 114.0691 | 25 | 154.19 | 17.61877 |
| 10 | 9 | 71.06907 | 54 | 53 | 115.0691 | 26 | 160.32 | 42.05 |
| 11 | 10 | 72.06907 | 55 | 54 | 116.0691 | 27 | 180 | 7.87815 |
| 12 | 11 | 73.06907 | 56 | 55 | 117.0691 | 28 | 180 | 23.47509 |
| 13 | 12 | 74.06907 | 57 | 56 | 118.0691 | 29 | 180 | 40.93451 |
| 14 | 13 | 75.06907 | 58 | 57 | 119.0691 | 30 | 199.68 | 42.05 |
| 15 | 14 | 76.06907 | 59 | 58 | 120.0691 | 31 | 205.81 | 17.61877 |
| 16 | 15 | 77.06907 | 60 | 59 | 121.0691 | 32 | 212.87 | 28.60436 |
| 17 | 16 | 78.06907 | 61 | 60 | 122.0691 | 33 | 215.9 | 39.62978 |
| 18 | 17 | 79.06907 | 62 | 61 | 123.0691 | 34 | 217.5 | 50.62533 |
| 19 | 18 | 80.06907 | 63 | 62 | 124.0691 | 35 | 232.5 | 50.62533 |
| 20 | 19 | 81.06907 | 64 | 63 | 125.0691 | 36 | 234.1 | 39.62978 |
| 21 | 20 | 82.06907 | 65 | 64 | 126.0691 | 37 | 237.13 | 28.60436 |
| 22 | 21 | 83.06907 | 66 | 65 | 127.0691 | 38 | 244.19 | 17.61877 |
| 23 | 22 | 84.06907 | 67 | 66 | 128.0691 | 39 | 250.32 | 42.05 |
| 24 | 23 | 85.06907 | 68 | 67 | 129.0691 | 40 | 270 | 7.87815 |
| 25 | 24 | 86.06907 | 69 | 68 | 130.0691 | 41 | 270 | 23.47509 |
| 26 | 25 | 87.06907 | 70 | 69 | 131.0691 | 42 | 270 | 40.93451 |
| 27 | 26 | 88.06907 | 71 | 70 | 132.0691 | 43 | 289.68 | 42.05 |
| 28 | 27 | 89.06907 | 72 | 71 | 133.0691 | 44 | 295.81 | 17.61877 |
| 29 | 28 | 90.06907 | 73 | 72 | 134.0691 | 45 | 302.87 | 28.60436 |
| 30 | 29 | 91.06907 | 74 | 73 | 135.0691 | 46 | 305.9 | 39.62978 |
| 31 | 30 | 92.06907 | 75 | 74 | 136.0691 | 47 | 307.5 | 50.62533 |
| 32 | 31 | 93.06907 | 76 | 75 | 137.0691 | 48 | 322.5 | 50.62533 |
| 33 | 32 | 94.06907 | 77 | 76 | 138.0691 | 49 | 324.1 | 39.62978 |
| 34 | 33 | 95.06907 | 78 | 77 | 139.0691 | 50 | 327.13 | 28.60436 |
| 35 | 34 | 96.06907 | 79 | 78 | 140.0691 | 51 | 334.19 | 17.61877 |
| 36 | 35 | 97.06907 | 80 | 79 | 141.0691 | 52 | 340.32 | 42.05 |
| 37 | 36 | 98.06907 | 81 | 80 | 142.0691 | | | |
| 38 | 37 | 99.06907 | 82 | 81 | 143.0691 | | | |
| 39 | 38 | 100.0691 | 83 | 82 | 144.0691 | | | |
| 40 | 39 | 101.0691 | 84 | 83 | 145.0691 | | | |
| 41 | 40 | 102.0691 | 85 | 84 | 146.0691 | | | |
| 42 | 41 | 103.0691 | 86 | 85 | 147.0691 | | | |
| 43 | 42 | 104.0691 | 87 | 86 | 148.0691 | | | |
| 44 | 43 | 105.0691 | 88 | 87 | 149.0691 | | | |
| | | | 89 | 88 | 150.0691 | | | |
| | | | 90 | 89 | 151.0691 | | | |
| | | | 91 | 90 | 152.0691 | | | |
| | | | 92 | 91 | 153.0691 | | | |

FIGS. 4 to 6 illustrate hemispheres of three different balls 30, 40 and 50 with different dimple patterns. The dimple patterns on balls 30, 40 and 50 are hereinafter referred to as dimple patterns 25-2, 25-3, and 25-4. Dimple patterns 25-2, 25-3 and 25-4 are related in that they have basically the same design except that each has a different number of rows of truncated dimples surrounding the equator. The dimple dimensions and positions for the balls of FIGS. 4 to 6 are provided below in Tables 5, 6 and 7, respectively.

Ball 30 or 25-2 of FIG. 4 has two rows of shallow truncated dimples 32 adjacent the equator in each hemisphere (i.e., a total of four rows in the complete ball), and spherical dimples 34 in each polar region. As indicated in Table 5, there are two different sizes of spherical dimples 34, and two different sizes of truncated dimple 32.

Ball 40 or 25-3 of FIG. 5 has four rows of shallow, truncated dimples 42 adjacent the equator in each hemisphere (i.e. a circumferential band of eight rows of shallow truncated dimples about the equator), and deep spherical dimples 44 in each polar region. As illustrated in FIG. 5 and indicated in Table 6, the truncated dimples 42 are Of three different sizes, with the largest size dimples 42A located only in the third and fourth TOWS of dimples from the equator (i.e. the two rows closest to the polar region). Ball 40 also has spherical dimples with slightly different radii, as indicated in Table 6.

Ball 50 or 25-4 of FIG. 6 has three rows of shallow, truncated dimples 52 on each side of the equator (i.e. a circumferential band of six rows of dimples around the equator) and deep spherical dimples 54 in each polar region. Ball 50 has spherical dimples of three different radii and truncated dimples which are also of three different radii, as indicated in Table 7. As illustrated in FIG. 6 and indicated in Table 7 below, the third row of truncated dimples, i.e. the row adjacent to the polar region, has some larger truncated dimples 52A, which are three of the largest truncated dimples identified as Dimple #5 in Table 7. The adjacent polar region also has some larger spherical dimples 54A arranged in a generally triangular pattern with the larger truncated dimples, as illustrated in FIG. 6. Dimples 54A are three of the largest spherical dimples identified as Dimple #6 in Table 7. As seen in Table 7, there are twelve total large truncated dimples #5 and twelve total large spherical dimples #6, all with a radius of 0.0875 inches. FIG. 6 illustrates the triangular arrangement of three large truncated dimples and three large spherical dimples at one location. Similar arrangements are provided at three equally spaced locations around the remainder of the hemisphere of the ball illustrated in FIG. 6.

As indicated in Tables 5, 6, and 7 below, the balls 25-2 and 25-3 each have three different sizes of truncated dimple in the equatorial region and two different sizes of spherical dimple in the polar region, while ball 25-4 has three different sizes of truncated dimple as well as three different sizes of spherical dimple. The polar region of dimples is largest in ball 25-2, which has four rows of truncated dimples (two rows per hemisphere) in the equatorial region, and smallest in ball 25-3, which has eight rows of truncated dimples in the equatorial region. In alternative embodiments, balls may be made with a single row of truncated dimples in each hemisphere, as well as with a land area having no dimples in an equatorial region, the land area or band having a width equal to two, four or more rows of dimples, or with a band having regions with dimples alternating with land regions with no dimples spaced around the equator.

TABLE 5
Dimple Pattern Design# = 25-2
Molding cavity internal diameter = 1.694″
Total number of dimples on ball = 336

| Dimple # 1 | | | Dimple # 2 | | | Dimple # 3 | | | Dimple # 4 | | | Dimple # 5 | | |
|---|---|---|---|---|---|---|---|---|---|---|---|---|---|---|
| Type truncated | | | Type spherical | | | Type truncated | | | Type truncated | | | Type spherical | | |
| Radius 0.0775 | | | Radius 0.0775 | | | Radius 0.0800 | | | Radius 0.0800 | | | Radius 0.0875 | | |
| SCD 0.0121 | | | SCD 0.0121 | | | SCD 0.0121 | | | SCD 0.0121 | | | SCD 0.0121 | | |
| TCD 0.0039 | | | TCD — | | | TCD 0.0039 | | | TCD 0.0039 | | | TCD — | | |
| # | Phi | Theta | # | Phi | Theta | # | Phi | Theta | # | Phi | Theta | # | Phi | Theta |
| 1 | 5.579593 | 73.51994 | 1 | 0 | 23.4884 | 1 | 5.591675 | 85.23955 | 1 | 0 | 7.947466 | 1 | 0 | 40.85302 |
| 2 | 16.75313 | 73.52028 | 2 | 13.0186 | 32.3247 | 2 | 16.84626 | 85.23955 | 2 | 26.63272 | 17.75117 | 2 | 0 | 62.32899 |
| 3 | 27.91657 | 73.52668 | 3 | 19.9156 | 42.17697 | 3 | 28.29145 | 85.23955 | 3 | 33.30007 | 28.68155 | 3 | 8.422648 | 51.28898 |
| 4 | 62.08343 | 73.52668 | 4 | 24.008 | 52.43641 | 4 | 39.24409 | 73.35107 | 4 | 36.11617 | 39.79409 | 4 | 13.60562 | 62.53208 |
| 5 | 73.24687 | 73.52028 | 5 | 26.4186 | 62.92891 | 5 | 39.40674 | 85.23955 | 5 | 37.72952 | 50.95749 | 5 | 76.39438 | 62.53208 |
| 6 | 84.42041 | 73.51994 | 6 | 63.5814 | 62.92891 | 6 | 50.59326 | 85.23955 | 6 | 38.62814 | 62.14951 | 6 | 81.57735 | 51.28898 |
| 7 | 95.57959 | 73.51994 | 7 | 65.992 | 52.43641 | 7 | 50.75591 | 73.35107 | 7 | 51.37186 | 62.14951 | 7 | 90 | 40.85302 |
| 8 | 106.7531 | 73.52028 | 8 | 70.0844 | 42.17697 | 8 | 61.70855 | 85.23955 | 8 | 52.27048 | 50.95749 | 8 | 90 | 62.32899 |
| 9 | 117.9166 | 73.52668 | 9 | 76.9814 | 32.3247 | 9 | 73.15374 | 85.23955 | 9 | 53.88383 | 39.79409 | 9 | 98.42265 | 51.28898 |
| 10 | 152.0834 | 73.52668 | 10 | 90 | 23.4884 | 10 | 84.40833 | 85.23955 | 10 | 56.69993 | 28.68155 | 10 | 103.6056 | 62.53208 |
| 11 | 163.2469 | 73.52028 | 11 | 103.019 | 32.3247 | 11 | 95.59167 | 85.23955 | 11 | 63.36728 | 17.75117 | 11 | 166.3944 | 62.53208 |
| 12 | 174.4204 | 73.51994 | 12 | 109.916 | 42.17697 | 12 | 106.8463 | 85.23955 | 12 | 90 | 7.947466 | 12 | 171.5774 | 51.28898 |
| 13 | 185.5796 | 73.51994 | 13 | 114.008 | 52.43641 | 13 | 118.2915 | 85.23955 | 13 | 116.6327 | 17.75117 | 13 | 180 | 40.85302 |
| 14 | 196.7531 | 73.52028 | 14 | 116.419 | 62.92891 | 14 | 129.2441 | 73.35107 | 14 | 123.3001 | 28.68155 | 14 | 180 | 62.32899 |
| 15 | 207.9166 | 73.52668 | 15 | 153.581 | 62.92891 | 15 | 129.4067 | 85.23955 | 15 | 126.1162 | 39.79409 | 15 | 188.4226 | 51.28898 |
| 16 | 242.0834 | 73.52668 | 16 | 155.992 | 52.43641 | 16 | 140.5933 | 85.23955 | 16 | 127.7295 | 50.95749 | 16 | 193.6056 | 62.53208 |
| 17 | 253.2469 | 73.52028 | 17 | 160.084 | 42.17697 | 17 | 140.7559 | 73.35107 | 17 | 128.6281 | 62.14951 | 17 | 256.3944 | 62.53208 |
| 18 | 264.4204 | 73.51994 | 18 | 166.981 | 32.3247 | 18 | 151.7085 | 85.23955 | 18 | 141.3719 | 62.14951 | 18 | 261.5774 | 51.28898 |
| 19 | 275.5796 | 73.51994 | 19 | 180 | 23.4884 | 19 | 163.1537 | 85.23955 | 19 | 142.2705 | 50.95749 | 19 | 270 | 40.85302 |
| 20 | 286.7531 | 73.52028 | 20 | 193.019 | 32.3247 | 20 | 174.4083 | 85.23955 | 20 | 143.8838 | 39.79409 | 20 | 270 | 62.32899 |
| 21 | 297.9166 | 73.52668 | 21 | 199.916 | 42.17697 | 21 | 185.5917 | 85.23955 | 21 | 146.6999 | 28.68155 | 21 | 278.4226 | 51.28898 |
| 22 | 332.0834 | 73.52668 | 22 | 204.008 | 52.43641 | 22 | 196.8463 | 85.23955 | 22 | 153.3673 | 17.75117 | 22 | 283.6056 | 62.53208 |
| 23 | 343.2469 | 73.52028 | 23 | 206.419 | 62.92891 | 23 | 208.2915 | 85.23955 | 23 | 180 | 7.947466 | 23 | 346.3944 | 62.53208 |
| 24 | 354.4204 | 73.51994 | 24 | 243.581 | 62.92891 | 24 | 219.2441 | 73.35107 | 24 | 206.6327 | 17.75117 | 24 | 351.5774 | 51.28898 |
| | | | 25 | 245.992 | 52.43641 | 25 | 219.4067 | 85.23955 | 25 | 213.3001 | 28.68155 | | | |
| | | | 26 | 250.084 | 42.17697 | 26 | 230.5933 | 85.23955 | 26 | 216.1162 | 39.79409 | | | |
| | | | 27 | 256.981 | 32.3247 | 27 | 230.7559 | 73.35107 | 27 | 217.7295 | 50.95749 | | | |
| | | | 28 | 270 | 23.4884 | 28 | 241.7085 | 85.23955 | 28 | 218.6281 | 62.14951 | | | |
| | | | 29 | 283.019 | 32.3247 | 29 | 253.1537 | 85.23955 | 29 | 231.3719 | 62.14951 | | | |
| | | | 30 | 289.916 | 42.17697 | 30 | 264.4083 | 85.23955 | 30 | 232.2705 | 50.95749 | | | |
| | | | 31 | 294.008 | 52.43641 | 31 | 275.5917 | 85.23955 | 31 | 233.8838 | 39.79409 | | | |
| | | | 32 | 296.419 | 62.92891 | 32 | 286.8463 | 85.23955 | 32 | 236.6999 | 28.68155 | | | |
| | | | 33 | 333.581 | 62.92891 | 33 | 298.2915 | 85.23955 | 33 | 243.3673 | 17.75117 | | | |
| | | | 34 | 335.992 | 52.43641 | 34 | 309.2441 | 73.35107 | 34 | 270 | 7.947466 | | | |
| | | | 35 | 340.084 | 42.17697 | 35 | 309.4067 | 85.23955 | 35 | 296.6327 | 17.75117 | | | |
| | | | 36 | 346.981 | 32.3247 | 36 | 320.5933 | 85.23955 | 36 | 303.3001 | 28.68155 | | | |
| | | | | | | 37 | 320.7559 | 73.35107 | 37 | 306.1162 | 39.79409 | | | |
| | | | | | | 38 | 331.7085 | 85.23955 | 38 | 307.7295 | 50.95749 | | | |
| | | | | | | 39 | 343.1537 | 85.23955 | 39 | 308.6281 | 62.14951 | | | |
| | | | | | | 40 | 354.4083 | 85.23955 | 40 | 321.3719 | 62.14951 | | | |
| | | | | | | | | | 41 | 322.2705 | 50.95749 | | | |
| | | | | | | | | | 42 | 323.8838 | 39.79409 | | | |
| | | | | | | | | | 43 | 326.6999 | 28.68155 | | | |
| | | | | | | | | | 44 | 333.3673 | 17.75117 | | | |

TABLE 6
Dimple Pattern Design# = 25-3
Molding cavity internal diameter = 1.694″
Total number of dimples on ball = 336

| Dimple # 1 | | | Dimple # 2 | | | Dimple # 3 | | | Dimple # 4 | | | Dimple # 5 | | |
|---|---|---|---|---|---|---|---|---|---|---|---|---|---|---|
| Type spherical | | | Type truncated | | | Type spherical | | | Type truncated | | | Type truncated | | |
| Radius 0.0775 | | | Radius 0.0800 | | | Radius 0.0800 | | | Radius 0.0775 | | | Radius 0.0875 | | |
| SCD 0.0121 | | | SCD 0.0121 | | | SCD 0.0121 | | | SCD 0.0121 | | | SCD 0.0121 | | |
| TCD — | | | TCD 0.0039 | | | TCD — | | | TCD 0.0039 | | | TCD 0.0039 | | |
| # | Phi | Theta | # | Phi | Theta | # | Phi | Theta | # | Phi | Theta | # | Phi | Theta |
| 1 | 0 | 23.4884 | 1 | 5.591675 | 85.23955 | 1 | 0 | 7.947466 | 1 | 5.579593 | 73.51994 | 1 | 0 | 62.32899 |
| 2 | 13.0186 | 32.3247 | 2 | 16.84626 | 85.23955 | 2 | 26.63272 | 17.75117 | 2 | 16.75313 | 73.52028 | 2 | 8.42265 | 51.28898 |
| 3 | 19.9156 | 42.17697 | 3 | 28.29145 | 85.23955 | 3 | 33.30007 | 28.68155 | 3 | 24.00802 | 52.43641 | 3 | 13.6056 | 62.53208 |
| 4 | 70.0844 | 42.17697 | 4 | 37.72952 | 50.95749 | 4 | 36.11617 | 39.79409 | 4 | 26.41855 | 62.92891 | 4 | 76.3944 | 62.53208 |
| 5 | 76.9814 | 32.3247 | 5 | 38.62814 | 62.14951 | 5 | 53.88383 | 39.79409 | 5 | 27.91657 | 73.52668 | 5 | 81.5774 | 51.28898 |
| 6 | 90 | 23.4884 | 6 | 39.24409 | 73.35107 | 6 | 56.69993 | 28.68155 | 6 | 62.08343 | 73.52668 | 6 | 90 | 62.32899 |
| 7 | 103.019 | 32.3247 | 7 | 39.40674 | 85.23955 | 7 | 63.36728 | 17.75117 | 7 | 63.58145 | 62.92891 | 7 | 98.4226 | 51.28898 |
| 8 | 109.916 | 42.17697 | 8 | 50.59326 | 85.23955 | 8 | 90 | 7.947466 | 8 | 65.99198 | 52.43641 | 8 | 103.606 | 62.53208 |
| 9 | 160.084 | 42.17697 | 9 | 50.75591 | 73.35107 | 9 | 116.6327 | 17.75117 | 9 | 73.24687 | 73.52028 | 9 | 166.394 | 62.53208 |
| 10 | 166.981 | 32.3247 | 10 | 51.37186 | 62.14951 | 10 | 123.3001 | 28.68155 | 10 | 84.42041 | 73.51994 | 10 | 171.577 | 51.28898 |
| 11 | 180 | 23.4884 | 11 | 52.27048 | 50.95749 | 11 | 126.1162 | 39.79409 | 11 | 95.57959 | 73.51994 | 11 | 180 | 62.32899 |
| 12 | 193.019 | 32.3247 | 12 | 61.70855 | 85.23955 | 12 | 143.8838 | 39.79409 | 12 | 106.7531 | 73.52028 | 12 | 188.423 | 51.28898 |
| 13 | 199.916 | 42.17697 | 13 | 73.15374 | 85.23955 | 13 | 146.6999 | 28.68155 | 13 | 114.008 | 52.43641 | 13 | 193.606 | 62.53208 |
| 14 | 250.084 | 42.17697 | 14 | 84.40833 | 85.23955 | 14 | 153.3673 | 17.75117 | 14 | 116.4186 | 62.92891 | 14 | 256.394 | 62.53208 |
| 15 | 256.981 | 32.3247 | 15 | 95.59167 | 85.23955 | 15 | 180 | 7.947466 | 15 | 117.9166 | 73.52668 | 15 | 261.577 | 51.28898 |
| 16 | 270 | 23.4884 | 16 | 106.8463 | 85.23955 | 16 | 206.6327 | 17.75117 | 16 | 152.0834 | 73.52668 | 16 | 270 | 62.32899 |
| 17 | 283.019 | 32.3247 | 17 | 118.2915 | 85.23955 | 17 | 213.3001 | 28.68155 | 17 | 153.5814 | 62.92891 | 17 | 278.423 | 51.28898 |
| 18 | 289.916 | 42.17697 | 18 | 127.7295 | 50.95749 | 18 | 216.1162 | 39.79409 | 18 | 155.992 | 52.43641 | 18 | 283.606 | 62.53208 |
| 19 | 340.084 | 42.17697 | 19 | 128.6281 | 62.14951 | 19 | 233.8838 | 39.79409 | 19 | 163.2469 | 73.52028 | 19 | 346.394 | 62.53208 |
| 20 | 346.981 | 32.3247 | 20 | 129.2441 | 73.35107 | 20 | 236.6999 | 28.68155 | 20 | 174.4204 | 73.51994 | 20 | 351.577 | 51.28898 |
| | | | 21 | 129.4067 | 85.23955 | 21 | 243.3673 | 17.75117 | 21 | 185.5796 | 73.51994 | 21 | 0 | 40.85302 |
| | | | 22 | 140.5933 | 85.23955 | 22 | 270 | 7.947466 | 22 | 196.7531 | 73.52028 | 22 | 90 | 40.85302 |
| | | | 23 | 140.7559 | 73.35107 | 23 | 296.6327 | 17.75117 | 23 | 204.008 | 52.43641 | 23 | 180 | 40.85302 |
| | | | 24 | 141.3719 | 62.14951 | 24 | 303.3001 | 28.68155 | 24 | 206.4186 | 62.92891 | 24 | 270 | 40.85302 |
| | | | 25 | 142.2705 | 50.95749 | 25 | 306.1162 | 39.79409 | 25 | 207.9166 | 73.52668 | | | |
| | | | 26 | 151.7085 | 85.23955 | 26 | 323.8838 | 39.79409 | 26 | 242.0834 | 73.52668 | | | |
| | | | 27 | 163.1537 | 85.23955 | 27 | 326.6999 | 28.68155 | 27 | 243.5814 | 62.92891 | | | |
| | | | 28 | 174.4083 | 85.23955 | 28 | 333.3673 | 17.75117 | 28 | 245.992 | 52.43641 | | | |
| | | | 29 | 185.5917 | 85.23955 | | | | 29 | 253.2469 | 73.52028 | | | |
| | | | 30 | 196.8463 | 85.23955 | | | | 30 | 264.4204 | 73.51994 | | | |
| | | | 31 | 208.2915 | 85.23955 | | | | 31 | 275.5796 | 73.51994 | | | |
| | | | 32 | 217.7295 | 50.95749 | | | | 32 | 286.7531 | 73.52028 | | | |
| | | | 33 | 218.6281 | 62.14951 | | | | 33 | 294.008 | 52.43641 | | | |
| | | | 34 | 219.2441 | 73.35107 | | | | 34 | 296.4186 | 62.92891 | | | |
| | | | 35 | 219.4067 | 85.23955 | | | | 35 | 297.9166 | 73.52668 | | | |
| | | | 36 | 230.5933 | 85.23955 | | | | 36 | 332.0834 | 73.52668 | | | |
| | | | 37 | 230.7559 | 73.35107 | | | | 37 | 333.5814 | 62.92891 | | | |
| | | | 38 | 231.3719 | 62.14951 | | | | 38 | 335.992 | 52.43641 | | | |
| | | | 39 | 232.2705 | 50.95749 | | | | 39 | 343.2469 | 73.52028 | | | |
| | | | 40 | 241.7085 | 85.23955 | | | | 40 | 354.4204 | 73.51994 | | | |
| | | | 41 | 253.1537 | 85.23955 | | | | | | | | | |
| | | | 42 | 264.4083 | 85.23955 | | | | | | | | | |
| | | | 43 | 275.5917 | 85.23955 | | | | | | | | | |
| | | | 44 | 286.8463 | 85.23955 | | | | | | | | | |
| | | | 45 | 298.2915 | 85.23955 | | | | | | | | | |
| | | | 46 | 307.7295 | 50.95749 | | | | | | | | | |
| | | | 47 | 308.6281 | 62.14951 | | | | | | | | | |
| | | | 48 | 309.2441 | 73.35107 | | | | | | | | | |
| | | | 49 | 309.4067 | 85.23955 | | | | | | | | | |
| | | | 50 | 320.5933 | 85.23955 | | | | | | | | | |
| | | | 51 | 320.7559 | 73.35107 | | | | | | | | | |
| | | | 52 | 321.3719 | 62.14951 | | | | | | | | | |
| | | | 53 | 322.2705 | 50.95749 | | | | | | | | | |
| | | | 54 | 331.7085 | 85.23955 | | | | | | | | | |
| | | | 55 | 343.1537 | 85.23955 | | | | | | | | | |
| | | | 56 | 354.4083 | 85.23955 | | | | | | | | | |

TABLE 7
Dimple Pattern Design# = 25-4
Molding cavity internal diameter = 1.694″
Total number of dimples on ball = 336

| Dimple # 1 | | | Dimple # 2 | | | Dimple # 3 | | | Dimple # 4 | | |
|---|---|---|---|---|---|---|---|---|---|---|---|
| Type truncated | | | Type spherical | | | Type truncated | | | Type spherical | | |
| Radius 0.0775 | | | Radius 0.0775 | | | Radius 0.0800 | | | Radius 0.0800 | | |
| SCD 0.0121 | | | SCD 0.0121 | | | SCD 0.0121 | | | SCD 0.0121 | | |
| TCD 0.0039 | | | TCD — | | | TCD 0.0039 | | | TCD — | | |
| # | Phi | Theta | # | Phi | Theta | # | Phi | Theta | # | Phi | Theta |
| 1 | 5.579593 | 73.5199369 | 1 | 0 | 23.4884 | 1 | 5.591675 | 85.2395467 | 1 | 0 | 7.947466 |
| 2 | 16.75313 | 73.5202824 | 2 | 13.0186 | 32.3247 | 2 | 16.84626 | 85.2395467 | 2 | 26.63272 | 17.75117 |
| 3 | 26.41855 | 62.9289055 | 3 | 19.9156 | 42.17697 | 3 | 28.29145 | 85.2395467 | 3 | 33.30007 | 28.68155 |
| 4 | 27.91657 | 73.5266783 | 4 | 24.008 | 52.43641 | 4 | 38.62814 | 62.1495131 | 4 | 36.11617 | 39.79409 |
| 5 | 62.08343 | 73.5266783 | 5 | 65.992 | 52.43641 | 5 | 39.24409 | 73.3510713 | 5 | 37.72952 | 50.95749 |
| 6 | 63.58145 | 62.9289055 | 6 | 70.0844 | 42.17697 | 6 | 39.40674 | 85.2395467 | 6 | 52.27048 | 50.95749 |
| 7 | 73.24687 | 73.5202824 | 7 | 76.9814 | 32.3247 | 7 | 50.59326 | 85.2395467 | 7 | 53.88383 | 39.79409 |
| 8 | 84.42041 | 73.5199369 | 8 | 90 | 23.4884 | 8 | 50.75591 | 73.3510713 | 8 | 56.69993 | 28.68155 |
| 9 | 95.57959 | 73.5199369 | 9 | 103.019 | 32.3247 | 9 | 51.37186 | 62.1495131 | 9 | 63.36728 | 17.75117 |
| 10 | 106.7531 | 73.5202824 | 10 | 109.916 | 42.17697 | 10 | 61.70855 | 85.2395467 | 10 | 90 | 7.947466 |
| 11 | 116.4186 | 62.9289055 | 11 | 114.008 | 52.43641 | 11 | 73.15374 | 85.2395467 | 11 | 116.6327 | 17.75117 |
| 12 | 117.9166 | 73.5266783 | 12 | 155.992 | 52.43641 | 12 | 84.40833 | 85.2395467 | 12 | 123.3001 | 28.68155 |
| 13 | 152.0834 | 73.5266783 | 13 | 160.084 | 42.17697 | 13 | 95.59167 | 85.2395467 | 13 | 126.1162 | 39.79409 |
| 14 | 153.5814 | 62.9289055 | 14 | 166.981 | 32.3247 | 14 | 106.8463 | 85.2395467 | 14 | 127.7295 | 50.95749 |
| 15 | 163.2469 | 73.5202824 | 15 | 180 | 23.4884 | 15 | 118.2915 | 85.2395467 | 15 | 142.2705 | 50.95749 |
| 16 | 174.4204 | 73.5199369 | 16 | 193.019 | 32.3247 | 16 | 128.6281 | 62.1495131 | 16 | 143.8838 | 39.79409 |
| 17 | 185.5796 | 73.5199369 | 17 | 199.916 | 42.17697 | 17 | 129.2441 | 73.3510713 | 17 | 146.6999 | 28.68155 |
| 18 | 196.7531 | 73.5202824 | 18 | 204.008 | 52.43641 | 18 | 129.4067 | 85.2395467 | 18 | 153.3673 | 17.75117 |
| 19 | 206.4186 | 62.9289055 | 19 | 245.992 | 52.43641 | 19 | 140.5933 | 85.2395467 | 19 | 180 | 7.947466 |
| 20 | 207.9166 | 73.5266783 | 20 | 250.084 | 42.17697 | 20 | 140.7559 | 73.3510713 | 20 | 206.6327 | 17.75117 |
| 21 | 242.0834 | 73.5266783 | 21 | 256.981 | 32.3247 | 21 | 141.3719 | 62.1495131 | 21 | 213.3001 | 28.68155 |
| 22 | 243.5814 | 62.9289055 | 22 | 270 | 23.4884 | 22 | 151.7085 | 85.2395467 | 22 | 216.1162 | 39.79409 |
| 23 | 253.2469 | 73.5202824 | 23 | 283.019 | 32.3247 | 23 | 163.1537 | 85.2395467 | 23 | 217.7295 | 50.95749 |
| 24 | 264.4204 | 73.5199369 | 24 | 289.916 | 42.17697 | 24 | 174.4083 | 85.2395467 | 24 | 232.2705 | 50.95749 |
| 25 | 275.5796 | 73.5199369 | 25 | 294.008 | 52.43641 | 25 | 185.5917 | 85.2395467 | 25 | 233.8838 | 39.79409 |
| 26 | 286.7531 | 73.5202824 | 26 | 335.992 | 52.43641 | 26 | 196.8463 | 85.2395467 | 26 | 236.6999 | 28.68155 |
| 27 | 296.4186 | 62.9289055 | 27 | 340.084 | 42.17697 | 27 | 208.2915 | 85.2395467 | 27 | 243.3673 | 17.75117 |
| 28 | 297.9166 | 73.5266783 | 28 | 346.981 | 32.3247 | 28 | 218.6281 | 62.1495131 | 28 | 270 | 7.947466 |
| 29 | 332.0834 | 73.5266783 | | | | 29 | 219.2441 | 73.3510713 | 29 | 296.6327 | 17.75117 |
| 30 | 333.5814 | 62.9289055 | | | | 30 | 219.4067 | 85.2395467 | 30 | 303.3001 | 28.68155 |
| 31 | 343.2469 | 73.5202824 | | | | 31 | 230.5933 | 85.2395467 | 31 | 306.1162 | 39.79409 |
| 32 | 354.4204 | 73.5199369 | | | | 32 | 230.7559 | 73.3510713 | 32 | 307.7295 | 50.95749 |
| | | | | | | 33 | 231.3719 | 62.1495131 | 33 | 322.2705 | 50.95749 |
| | | | | | | 34 | 241.7085 | 85.2395467 | 34 | 323.8838 | 39.79409 |
| | | | | | | 35 | 253.1537 | 85.2395467 | 35 | 326.6999 | 28.68155 |
| | | | | | | 36 | 264.4083 | 85.2395467 | 36 | 333.3673 | 17.75117 |
| | | | | | | 37 | 275.5917 | 85.2395467 | | | |
| | | | | | | 38 | 286.8463 | 85.2395467 | | | |
| | | | | | | 39 | 298.2915 | 85.2395467 | | | |
| | | | | | | 40 | 308.6281 | 62.1495131 | | | |
| | | | | | | 41 | 309.2441 | 73.3510713 | | | |
| | | | | | | 42 | 309.4067 | 85.2395467 | | | |
| | | | | | | 43 | 320.5933 | 85.2395467 | | | |
| | | | | | | 44 | 320.7559 | 73.3510713 | | | |
| | | | | | | 45 | 321.3719 | 62.1495131 | | | |
| | | | | | | 46 | 331.7085 | 85.2395467 | | | |
| | | | | | | 47 | 343.1537 | 85.2395467 | | | |
| | | | | | | 48 | 354.4083 | 85.2395467 | | | |

| Dimple # 5 | | | Dimple # 6 | | |
|---|---|---|---|---|---|
| Type truncated | | | Type spherical | | |
| Radius 0.0875 | | | Radius 0.0875 | | |
| SCD 0.0121 | | | SCD 0.0121 | | |
| TCD 0.0039 | | | TCD — | | |
| # | Phi | Theta | # | Phi | Theta |
| 1 | 0 | 62.3289928 | 1 | 0 | 40.85302 |
| 2 | 13.60562 | 62.5320764 | 2 | 8.42265 | 51.28898 |
| 3 | 76.39438 | 62.5320764 | 3 | 81.5774 | 51.28898 |
| 4 | 90 | 62.3289928 | 4 | 90 | 40.85302 |
| 5 | 103.6056 | 62.5320764 | 5 | 98.4226 | 51.28898 |
| 6 | 166.3944 | 62.5320764 | 6 | 171.577 | 51.28898 |
| 7 | 180 | 62.3289928 | 7 | 180 | 40.85302 |
| 8 | 193.6056 | 62.5320764 | 8 | 188.423 | 51.28898 |
| 9 | 256.3944 | 62.5320764 | 9 | 261.577 | 51.28898 |
| 10 | 270 | 62.3289928 | 10 | 270 | 40.85302 |
| 11 | 283.6056 | 62.5320764 | 11 | 278.423 | 51.28898 |
| 12 | 346.3944 | 62.5320764 | 12 | 351.577 | 51.28898 |

Dimple patterns 25-2, 25-3 and 25-4 are similar to pattern 2-9 in that they have truncated dimples around the equatorial region and deeper dimples around the pole region, but the truncated dimples in patterns 25-2, 25-3 and 25-4 are of larger diameter than the truncated dimples of patterns 28-1, 25-1 and 2-9. The larger truncated dimples near the equator means that more weight is removed from the equator area. With all other factors being equal, this means that there is a smaller MOI difference between the PH and POP orientations for balls 25-2, 25-3 and 25-4 than for balls 28-1, 28-2, 25-1 and 2-9.

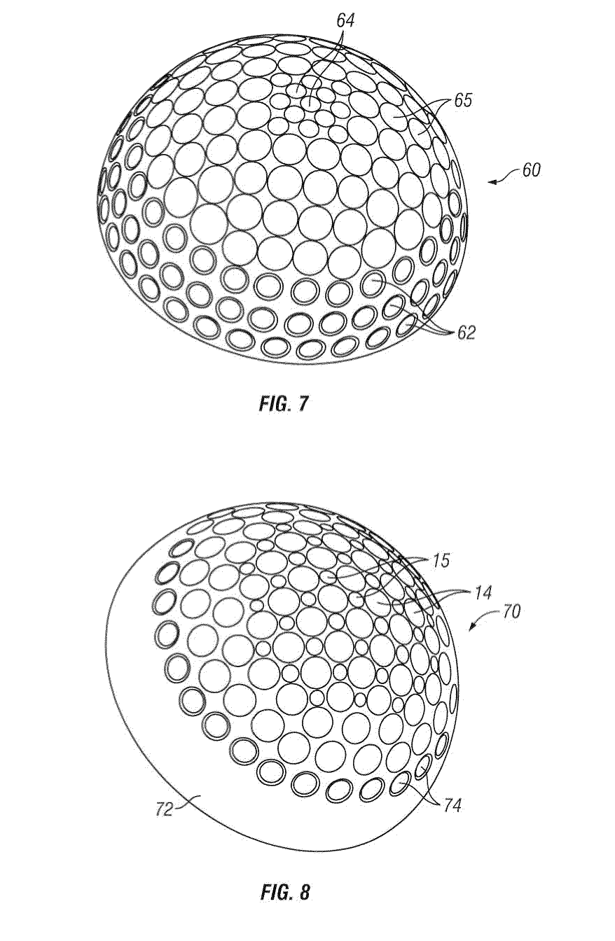

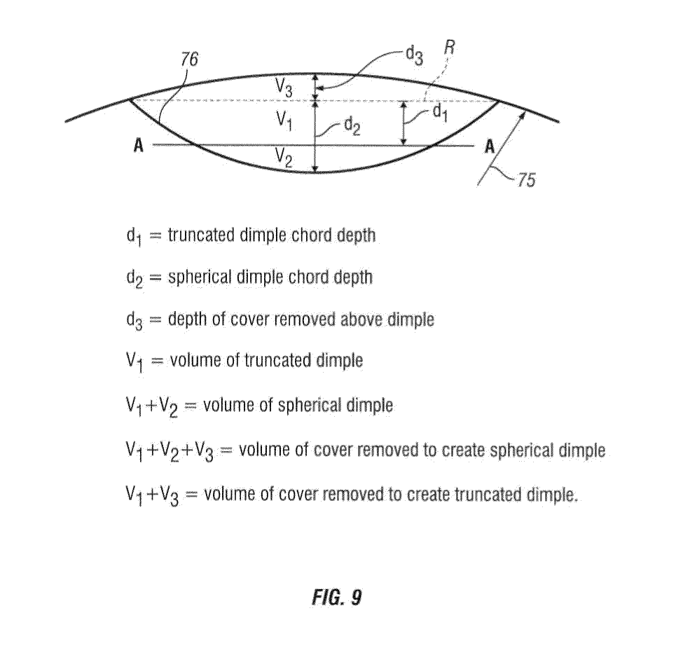

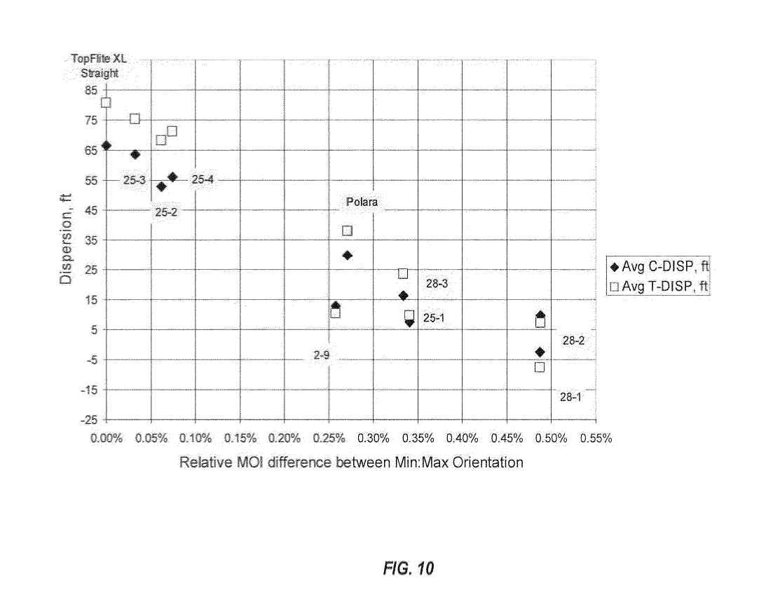

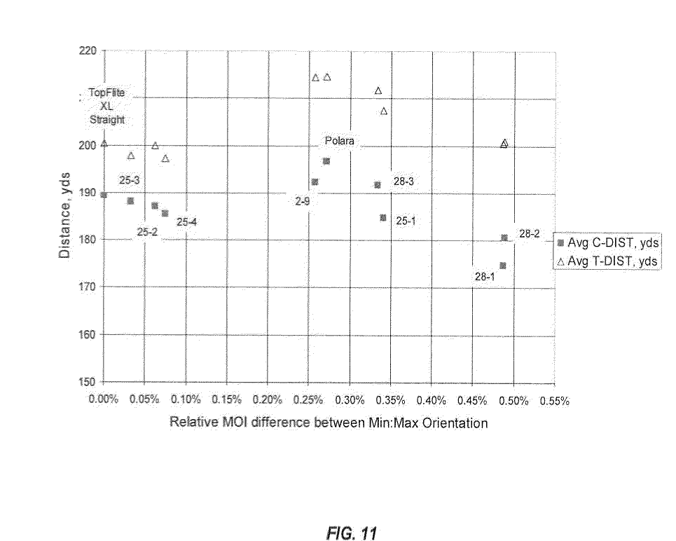

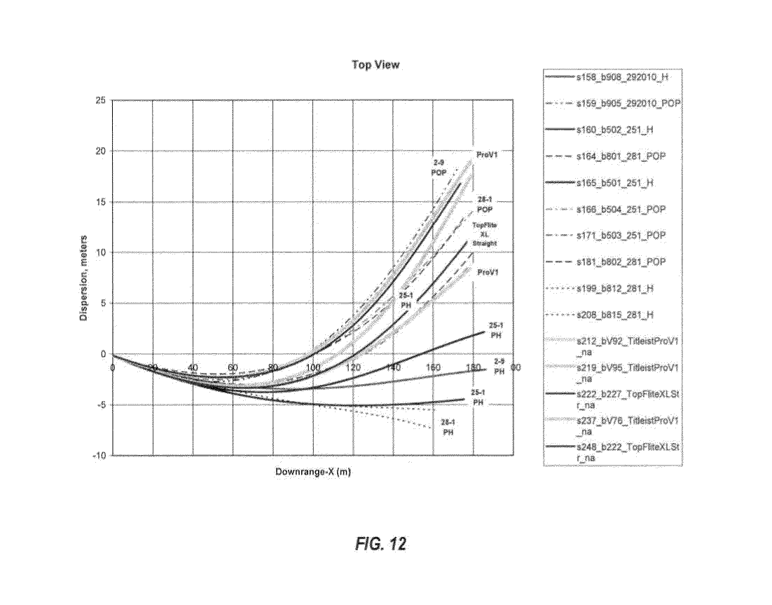

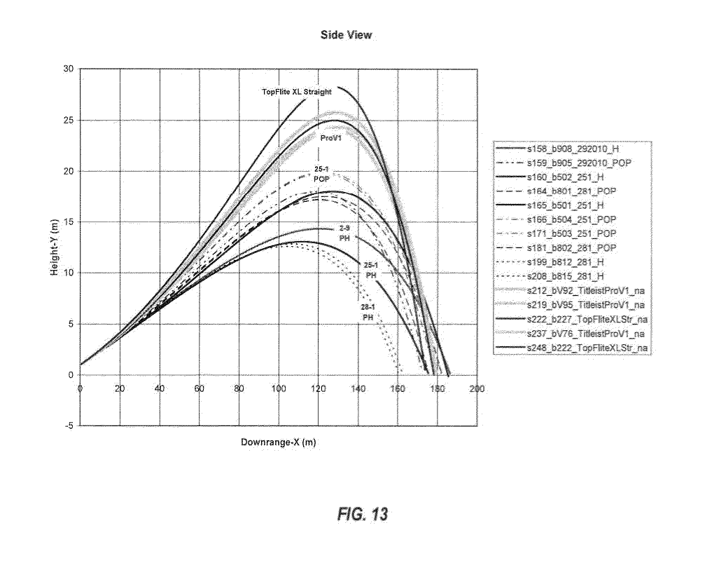

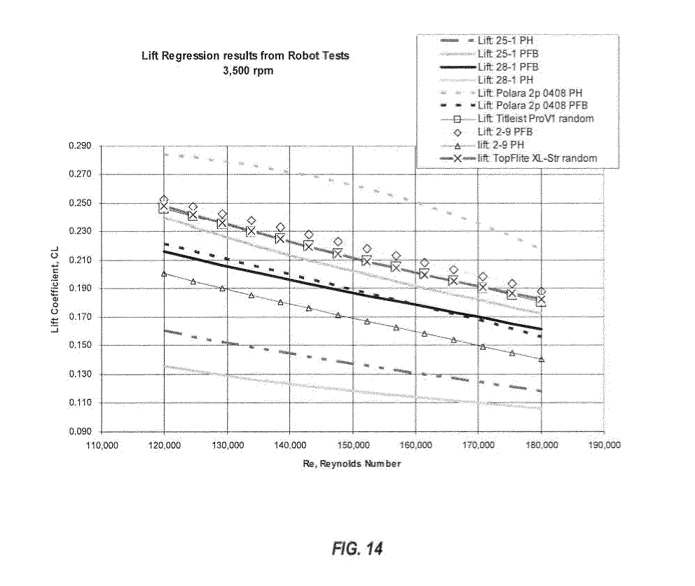

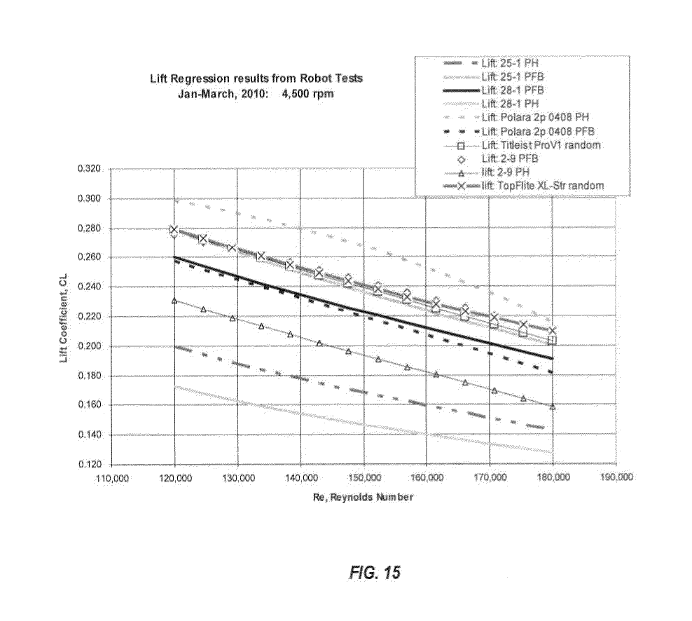

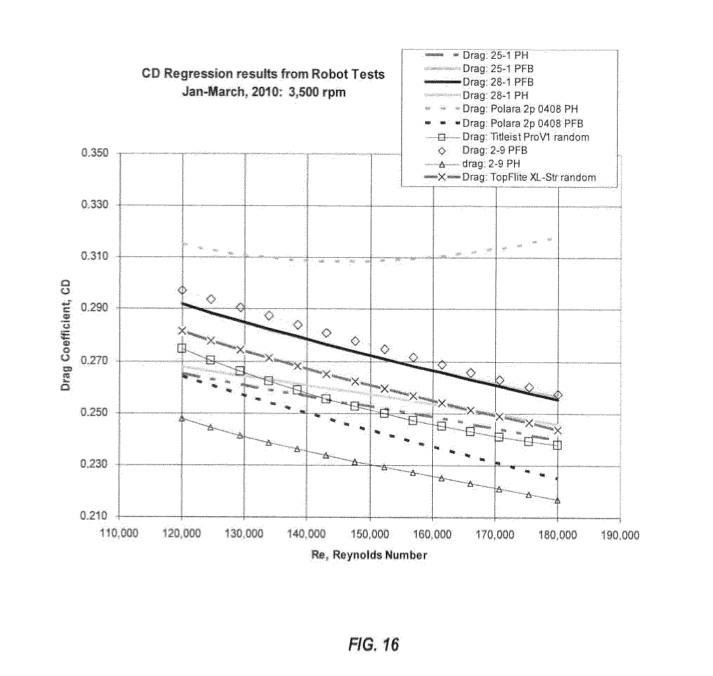

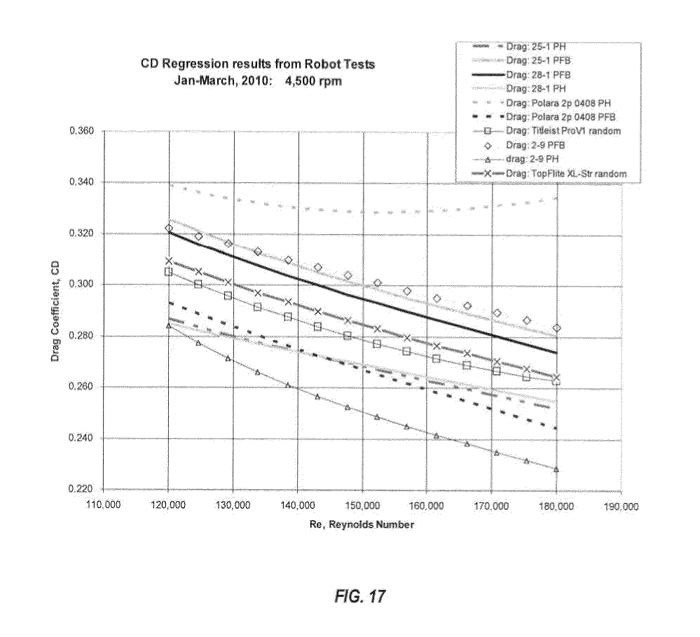

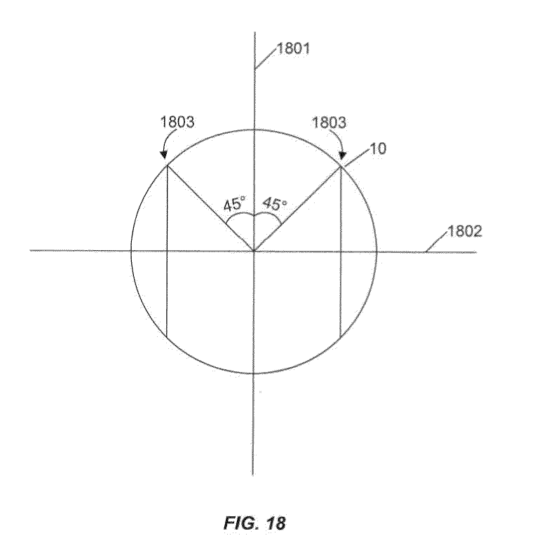

FIG. 7 illustrates one hemisphere of a golf ball 60 according to another embodiment, which has a different dimple pattern identified as dimple pattern 28-3 in the following description. Dimple pattern 28-3 of ball 60 comprises three rows of truncated dimples 62 on each side of the equator, an area of small spherical dimples 64 at each pole, and an area of larger, deep spherical dimples 65 between dimples 64 and dimples 62. Table 8 indicates the dimple parameters and coordinates for golf ball 60. As illustrated in Table 8, ball 28-3 has one size of truncated dimple, four sizes of larger spherical dimples (dimple numbers 2, 3, 5 and 6) and one size of smaller spherical dimple (dimple number 1) in the polar regions.

As indicated in Table 8 and FIG. 7, the small spherical dimples 64 at the pole are all of the same radius, and there are thirteen dimples 64 arranged in a generally square pattern centered on the pole of each hemisphere. There are four different larger spherical dimples 65 (dimple numbers 2 to 6 of Table 8) of progressively increasing radius from 0.075 inches to 0.0825 inches. The ball with dimple pattern 28-3 also has a preferred spin axis through the poles due to the weight difference caused by locating a larger volume of dimples in each polar region than in the equatorial band around the equator.

The dimple parameters and coordinates for making one hemisphere of the 28-3 ball are listed below in Table 8.

TABLE 8
Dimple Pattern Design# 28-3
Molding cavity internal diameter = 1.692″
Total number of dimples on ball = 354

| Dimple # 1 | | | Dimple # 2 | | | Dimple # 3 | | |
|---|---|---|---|---|---|---|---|---|
| Type spherical | | | Type spherical | | | Type spherical | | |
| Radius 0.0475 | | | Radius 0.0750 | | | Radius 0.0775 | | |
| SCD 0.0080 | | | SCD 0.0080 | | | SCD 0.0080 | | |
| TCD — | | | TCD — | | | TCD — | | |
| # | Phi | Theta | # | Phi | Theta | # | Phi | Theta |
| 1 | 0 | 0 | 1 | 12.927785 | 31.884481 | 1 | 0 | 23.102459 |
| 2 | 0 | 6.6748046 | 2 | 77.072215 | 31.884481 | 2 | 27.477912 | 18.124586 |
| 3 | 0 | 13.353545 | 3 | 102.92779 | 31.884481 | 3 | 62.522088 | 18.124586 |
| 4 | 45 | 9.4610963 | 4 | 167.07221 | 31.884481 | 4 | 90 | 23.102459 |
| 5 | 90 | 6.6748046 | 5 | 192.92779 | 31.884481 | 5 | 117.47791 | 18.124586 |
| 6 | 90 | 13.353545 | 6 | 257.07221 | 31.884481 | 6 | 152.52209 | 18.124586 |
| 7 | 135 | 9.4610963 | 7 | 282.92779 | 31.884481 | 7 | 180 | 23.102459 |
| 8 | 180 | 6.6748046 | 8 | 347.07221 | 31.884481 | 8 | 207.47791 | 18.124586 |
| 9 | 180 | 13.353545 | | | | 9 | 242.52209 | 18.124586 |
| 10 | 225 | 9.4610963 | | | | 10 | 270 | 23.102459 |
| 11 | 270 | 6.6748046 | | | | 11 | 297.47791 | 18.124586 |
| 12 | 270 | 13.353545 | | | | 12 | 332.52209 | 18.124586 |
| 13 | 315 | 9.4610963 | | | | | | |

| Dimple # 5 | | | Dimple # 6 | | |
|---|---|---|---|---|---|
| Type spherical | | | Type spherical | | |
| Radius 0.0800 | | | Radius 0.0825 | | |
| SCD 0.0080 | | | SCD 0.0080 | | |
| TCD — | | | TCD — | | |
| # | Phi | Theta | # | Phi | Theta |
| 1 | 23.959474 | 52.85795 | 1 | 19.446897 | 42.09101 |
| 2 | 33.420036 | 28.804503 | 2 | 70.553103 | 42.09101 |
| 3 | 36.311426 | 39.777883 | 3 | 109.4469 | 42.09101 |
| 4 | 37.838691 | 50.813627 | 4 | 160.5531 | 42.09101 |
| 5 | 52.161309 | 50.813627 | 5 | 199.4469 | 42.09101 |
| 6 | 53.688574 | 39.777883 | 6 | 250.5531 | 42.09101 |
| 7 | 56.579964 | 28.804503 | 7 | 289.4469 | 42.09101 |
| 8 | 66.040526 | 52.85795 | 8 | 340.5531 | 42.09101 |
| 9 | 113.95947 | 52.85795 | 9 | 0 | 40.242952 |
| 10 | 123.42004 | 28.804503 | 10 | 90 | 40.242952 |
| 11 | 126.31143 | 39.777883 | 11 | 180 | 40.242952 |
| 12 | 127.83869 | 50.813627 | 12 | 270 | 40.242952 |
| 13 | 142.16131 | 50.813627 | 13 | 8.3680473 | 51.180102 |
| 14 | 143.68857 | 39.777883 | 14 | 81.631953 | 51.180102 |
| 15 | 146.57996 | 28.804503 | 15 | 98.368047 | 51.180102 |
| 16 | 156.04053 | 52.85795 | 16 | 171.63195 | 51.180102 |
| 17 | 203.95947 | 52.85795 | 17 | 188.36805 | 51.180102 |
| 18 | 213.42004 | 28.804503 | 18 | 261.63195 | 51.180102 |
| 19 | 216.31143 | 39.777883 | 19 | 278.36805 | 51.180102 |
| 20 | 217.83869 | 50.813627 | 20 | 351.63195 | 51.180102 |
| 21 | 232.16131 | 50.813627 | | | |
| 22 | 233.68857 | 39.777883 | | | |
| 23 | 236.57996 | 28.804503 | | | |
| 24 | 246.04053 | 52.85795 | | | |
| 25 | 293.95947 | 52.85795 | | | |
| 26 | 303.42004 | 28.804503 | | | |
| 27 | 306.31143 | 39.777883 | | | |
| 28 | 307.83869 | 50.813627 | | | |
| 29 | 322.16131 | 50.813627 | | | |
| 30 | 323.68857 | 39.777883 | | | |
| 31 | 326.57996 | 28.804503 | | | |
| 32 | 336.04053 | 52.85795 | | | |

Dimple # 4
Type truncated
Radius 0.0670
SCD 0.0121
TCD 0.0039

| # | Phi | Theta |
|---|---|---|
| 1 | 0 | 62.0690668 |
| 2 | 0 | 83.5 |
| 3 | 5.65 | 73.3833254 |
| 4 | 11.26 | 83.5 |
| 5 | 13.34 | 62.0690668 |
| 6 | 16.83 | 73.3833254 |
| 7 | 22.66 | 83.5 |
| 8 | 26.32 | 62.8658456 |
| 9 | 27.98 | 73.3833254 |
| 10 | 33.82 | 83.5 |
| 11 | 38.44 | 61.760315 |
| 12 | 39.02 | 73.3833254 |
| 13 | 45 | 83.5 |
| 14 | 50.98 | 73.3833254 |
| 15 | 51.56 | 61.760315 |
| 16 | 56.18 | 83.5 |
| 17 | 62.02 | 73.3833254 |
| 18 | 63.68 | 62.8658456 |
| 19 | 67.34 | 83.5 |
| 20 | 73.17 | 73.3833254 |
| 21 | 76.66 | 62.0690668 |
| 22 | 78.74 | 83.5 |
| 23 | 84.35 | 73.3833254 |
| 24 | 90 | 62.0690668 |
| 25 | 90 | 83.5 |
| 26 | 95.65 | 73.3833254 |
| 27 | 101.26 | 83.5 |
| 28 | 103.34 | 62.0690668 |
| 29 | 106.83 | 73.3833254 |
| 30 | 112.66 | 83.5 |
| 31 | 116.32 | 62.8658456 |
| 32 | 117.98 | 73.3833254 |
| 33 | 123.82 | 83.5 |
| 34 | 128.44 | 61.760315 |
| 35 | 129.02 | 73.3833254 |
| 36 | 135 | 83.5 |
| 37 | 140.98 | 73.3833254 |
| 38 | 141.56 | 61.760315 |
| 39 | 146.18 | 83.5 |
| 40 | 152.02 | 73.3833254 |
| 41 | 153.68 | 62.8658456 |
| 42 | 157.34 | 83.5 |
| 43 | 163.17 | 73.3833254 |
| 44 | 166.66 | 62.0690668 |
| 45 | 168.74 | 83.5 |
| 46 | 174.35 | 73.3833254 |
| 47 | 180 | 62.0690668 |
| 48 | 180 | 83.5 |
| 49 | 185.65 | 73.3833254 |
| 50 | 191.26 | 83.5 |
| 51 | 193.34 | 62.0690668 |
| 52 | 196.83 | 73.3833254 |
| 53 | 202.66 | 83.5 |
| 54 | 206.32 | 62.86585 |
| 55 | 207.98 | 73.38333 |
| 56 | 213.82 | 83.5 |
| 57 | 218.44 | 61.76032 |
| 58 | 219.02 | 73.38333 |
| 59 | 225 | 83.5 |
| 60 | 230.98 | 73.38333 |
| 61 | 231.56 | 61.76032 |
| 62 | 236.18 | 83.5 |
| 63 | 242.02 | 73.38333 |
| 64 | 243.68 | 62.86585 |
| 65 | 247.34 | 83.5 |
| 66 | 253.17 | 73.38333 |
| 67 | 256.66 | 62.06907 |
| 68 | 258.74 | 83.5 |
| 69 | 264.35 | 73.38333 |
| 70 | 270 | 62.06907 |
| 71 | 270 | 83.5 |
| 72 | 275.65 | 73.38333 |
| 73 | 281.26 | 83.5 |
| 74 | 283.34 | 62.06907 |
| 75 | 286.83 | 73.38333 |
| 76 | 292.66 | 83.5 |
| 77 | 296.32 | 62.86585 |
| 78 | 297.98 | 73.38333 |
| 79 | 303.82 | 83.5 |
| 80 | 308.44 | 61.76032 |
| 81 | 309.02 | 73.38333 |
| 82 | 315 | 83.5 |
| 83 | 320.98 | 73.38333 |
| 84 | 321.56 | 61.76032 |
| 85 | 326.18 | 83.5 |
| 86 | 332.02 | 73.38333 |
| 87 | 333.68 | 62.86585 |
| 88 | 337.34 | 83.5 |
| 89 | 343.17 | 73.38333 |
| 90 | 346.66 | 62.06907 |
| 91 | 348.74 | 83.5 |
| 92 | 354.35 | 73.38333 |

In one example, the seam widths for balls 28-1, 28-2, and 28-3 was 0.0088″ total (split on each hemisphere), while the seam widths for balls 25-2, 25-3, and 25-4 was 0.006″, and the seam width for ball 25-1 was 0.030″.

Each of the dimple patterns described above and illustrated in FIGS. 1 to 7 has less dimple volume in a band around the equator and more dimple volume in the polar region. The balls with these dimple patterns have a preferred spin axis extending through the poles, so that slicing and hooking is resisted if the ball is placed on the tee with the preferred spin axis substantially horizontal. If placed on the tee with the preferred spin axis pointing up and down (POP orientation), the ball is much less effective in correcting hooks and slices compared to being oriented in the PH orientation. If desired, the ball may also be oriented on the tee with the preferred spin axis tilted up by about 45 degrees to the right, and in this ease the ball still reduces slice dispersion, but does not reduce hook dispersion as much. If the preferred spin axis is tilted up by about 45 degrees to the left, the ball reduces hook dispersion but does not resist slice dispersion as much.

FIG. 8 illustrates a ball 70 with a dimple pattern similar to the ball 28-1 of FIG. 1 but which has a wider region or land region 72 with no dimples about the equator. In the embodiment of FIG. 8, the region 72 is formed by removing two rows of dimples on each side of the equator from the ball 10 of FIG. 1, leaving one row of shallow truncated dimples 74. The polar region of dimples is identical to that of FIG. 1, and like reference numbers are used for like dimples. Rows of truncated dimples may be removed from any of the balls of FIGS. 2 to 7 in a similar manner to leave a dimpleless region or land area about the equator. The dimpleless region in some embodiments may be narrow, like a wider seam, or may be wider by removing one, two, or all of the rows of truncated dimples next to the equator, producing a larger MOI difference between the poles horizontal (PH) and other orientations.

FIG. 9 is a diagram, illustrating the relationship between the chord depth of a truncated and a spherical dimple as used in the dimple patterns of the golf balls described above. A golf ball having a diameter of about 1.68 inches was molded using a mold with an inside diameter of approximately 1.694 inches to accommodate for the polymer shrinkage. FIG. 9 illustrates part of the surface 75 of the golf ball with a spherical dimple 76 of spherical chord depth of d₂ and a radius R represented by half the length of the dotted line. In order to form a truncated dimple, a cut is made along plane A-A to make the dimple shallower, with the truncated dimple having a truncated chord depth of d₁, which is smaller than the spherical chord depth d₂. The volume of cover material removed above the edges of the dimple is represented by volume V3 above the dotted line, with a depth d₃. In FIG. 9,

V1=volume of truncated dimple,
V1+V2=volume of spherical dimple,
V1+V2+V3=volume of cover removed, to create spherical dimple, and
V1+V3=volume of cover removed to create truncated dimple.
For dimples that are based on the same radius and spherical chord depth, the moment of inertia difference between a ball with truncated dimples and spherical dimples is related to the volume V2 below line or plane A-A which is removed in forming a spherical dimple and not removed for the truncated dimple. A ball with all other factors being the same except that one has only truncated dimples and the other has only spherical dimples, with the difference between the truncated and spherical dimples being only the volume V2 (i.e. all other dimple parameters are the same), the ball with truncated dimples is of greater weight and has a higher MOI than the ball with spherical dimples, which has more material removed from the surface to create the dimples.

The approximate moment of inertia can be calculated for each of the balls illustrated in FIGS. 1 to 7 and in Tables 1 to 8 (i.e. balls 2-9, 25-1 to 25-4, and 28-1 to 28-3). In one embodiment, balls having these patterns were drawn in SolidWorks® and their MOI 's were calculated along with the known Polara™ golf ball referenced above as a standard. SolidWorks® was used to calculate the MOI 's based on each ball having a uniform solid density of 0.036413 lbs/in̂3. The other physical size and weight parameters for each ball are given in Table 9 below.

TABLE 9

| | | | | | surface |
|---|---|---|---|---|---|
| | density, | mass, | mass, | volume, | area, |
| Ball | lbs/in\hat{ }3 | lbs | grams | inch\hat{ }3 | inch\hat{ }2 |
| Polara | 0.03613 | 0.09092 | 41.28 | 2.517 | 13.636 |
| 2-9 | 0.03613 | 0.09064 | 41.15 | 2.509 | 13.596 |
| 25-1 | 0.03613 | 0.09060 | 41.13 | 2.508 | 13.611 |
| 25-2 | 0.03613 | 0.09024243 | 40.97 | 2.4979025 | 13.560402 |
| 25-3 | 0.03613 | 0.09028772 | 40.99 | 2.4991561 | 13.575728 |
| 25-4 | 0.03613 | 0.09026686 | 40.98 | 2.4985787 | 13.568852 |
| 28-1 | 0.03613 | 0.09047 | 41.07 | 2.504 | 13.609 |
| 28-2 | 0.03613 | 0.09047 | 41.07 | 2.504 | 13.609 |
| 28-3 | 0.03613 | 0.09053814 | 41.1 | 2.5060878 | 13.556403 |

The MOI for each ball was calculated based on the dimple pattern information and the physical information in Table 9. Table 10 shows the MOI calculations.

TABLE 10

| | | | | | | | | % MOI |
|---|---|---|---|---|---|---|---|---|
| | | | | | | | | delta |
| | Px, lbs × | Py, lbs × | Pz, lbs × | | | MOI Delta = | % (Pmax − | relative to |
| Ball | inch\hat{ }2 | inch\hat{ }2 | inch\hat{ }2 | Pmax | Pmin | Pmax − Pmin | Pmin)/Pmax | Polara |
| Polara | 0.025848 | 0.025917 | 0.025919 | 0.025919 | 0.025848 | 0.0000703 | 0.271% | 0.0% |
| 2-9 | 0.025740 | 0.025741 | 0.025806 | 0.025806 | 0.025740 | 0.0000665 | 0.258% | −5.0% |
| 25-1 | 0.025712 | 0.025713 | 0.025800 | 0.025800 | 0.025712 | 0.0000880 | 0.341% | 25.7% |
| 25-2 | 0.02556791 | 0.02557031 | 0.02558386 | 0.0255839 | 0.0255679 | 1.595E−05 | 0.062% | −77.0% |
| 25-3 | 0.0255822 | 0.02558822 | 0.02559062 | 0.0255906 | 0.0255822 | 8.42E−06 | 0.033% | −87.9% |
| 25-4 | 0.02557818 | 0.02558058 | 0.02559721 | 0.0255972 | 0.0255782 | 1.903E−05 | 0.074% | −72.6% |
| 28-1 | 0.025638 | 0.025640 | 0.025764 | 0.025764 | 0.025638 | 0.0001254 | 0.487% | 79.5% |
| 28-2 | 0.025638 | 0.025640 | 0.025764 | 0.025764 | 0.025638 | 0.0001258 | 0.488% | 80.0% |
| 28-3 | 0.02568461 | 0.02568647 | 0.02577059 | 0.0257706 | 0.0256846 | 8.598E−05 | 0.334% | 23.0% |

With the Polara™ golf ball as a standard, the MOI differences between each orientation were compared to the Polara golf ball in addition to being compared to each other. The largest difference between any two orientations is called the “MOI Delta”, shown in table 10. The two columns to the right quantify the MOI Delta in terms of the maximum % difference in MOI between two orientations and the MOI Delta relative to the MOI Delta for the Polara ball: Because the density value used to calculate the mass and MOI was lower than the average density of a golf ball, the predicted weight and MOI for each ball is relative to each other, but not exactly the same as the actual MOI values of the golf balls that were made, robot tested and shown in Table 10. Generally a golf ball weighs about 45.5-45.9 g. Comparing the MOI values of all of the halls in Table 10 is quite instructive, in that it predicts the relative order of MOI difference between the different designs, with the 25-3 hall having the smallest MOI difference and ball 28-2 having the largest MOI difference.

Table 11 shows that a ball's MOI Delta does strongly influence the ball's dispersion control. In general as the relative MOI Delta of each ball increases, the dispersion distance for a slice shot decreases. The results illustrated in Table 11 also include data obtained from testing a known TopFlite XL straight ball, and were obtained during robot testing under standard laboratory conditions, as discussed in more detail below.

TABLE 11

| | | % MOI | | | | |
|---|---|---|---|---|---|---|
| | | difference | | | | |
| | | between | Avg C-DISP, | Avg C-DIST, | Avg T-DISP, | Avg T-DIST, |
| Ball | Orientation | orientations | ft | yds | ft | yds |
| 28-2 | PH | 0.488% | 9.6 | 180.6 | 7.3 | 201.0 |
| 28-1 | PH | 0.487% | −2.6 | 174.8 | −7.6 | 200.5 |
| TopFLite XL | random | 0.000% | 66.5 | 189.3 | 80.6 | 200.4 |
| Straight | | | | | | |
| 25-1 | PH | 0.341% | 7.4 | 184.7 | 9.6 | 207.5 |
| 28-3 | PH | 0.334% | 16.3 | 191.8 | 23.5 | 211.8 |
| Polara | PFB | 0.271% | 29.7 | 196.6 | 38.0 | 214.6 |
| 2-9 | PH | 0.258% | 12.8 | 192.2 | 10.5 | 214.5 |
| 25-4 | PH | 0.074% | 56.0 | 185.4 | 71.0 | 197.3 |
| 25-2 | PH | 0.062% | 52.8 | 187.0 | 68.1 | 199.9 |
| 25-3 | PH | 0.033% | 63.4 | 188.0 | 75.1 | 197.9 |

As illustrated in Table 11, balls 28-3, 25-1, 28-1 and 28-2 all have higher MOI deltas relative to the Polara, and they all have better dispersion control than the Polara. This MOI difference is also shown in FIGS. 10 and 11, which also includes test data for the TopFlite XL Straight made by Callaway Golf.

The aerodynamic force acting on a golf ball during flight can be broken down into three separate force vectors: Lift, Drag, and Gravity. The lift force vector acts in the direction determined by the cross product of the spin vector and the velocity vector. The drag force vector acts in the direction opposite of the velocity vector. More specifically, the aerodynamic properties of a golf ball are characterized by its lift and drag coefficients as a function of the Reynolds Number (Re) and the Dimensionless Spin Parameter (DSP). The Reynolds Number is a dimensionless quantity that quantities the ratio of the inertial to viscous forces acting on the golf ball as it flies through the air. The Dimensionless Spin Parameter is the ratio of the golf balls rotational surface speed to its speed through the air.

The lift and drag coefficients of a golf ball can be measured using several different methods including an Indoor Test Range such as the one at the USGA Test Center in Far Hills, N.J. or an outdoor system such as the Trackman Net System made by Interactive Sports Group in Denmark. The test results described below and illustrated in FIGS. 10 to 17 for some of the embodiments described above as well as some conventional golf balls for comparison purposes were obtained using a Trackman Net System.

For right-handed golfers, particularly higher handicap golfers, a major problem is the tendency to “slice” the ball. The unintended slice shot penalizes the golfer in two ways: 1) it causes the ball to deviate to the right of the intended flight path and 2) it can reduce the overall shot distance. A sliced golf ball moves to the right because the ball's spin axis is tilted to the right. The lift force by definition is orthogonal to the spin axis and thus for a sliced golf ball the lift force is pointed to the right.

The spin-axis of a golf ball is the axis about which the ball spins and is usually orthogonal to the direction that the golf ball takes in flight. If a golf ball's spin axis is 0 degrees, i.e., a horizontal spin axis causing pure backspin, the ball does not hook or slice and a higher lift force combined with a 0-degree spin axis only makes the ball fly higher. However, when a ball is hit in such a way as to impart a spin axis that is more than 0 degrees, it hooks, and it slices with a spin axis that is less than 0 degrees. It is the tilt of the spin axis that directs the lift force in the left or right direction, causing the ball to hook or slice. The distance the ball unintentionally flies to the right or left is called Carry Dispersion. A lower flying golf ball, i.e., having a lower lift, is a strong indicator of ball that has lower Carry Dispersion.

The amount of lift force directed in the hook or slice direction is equal to: Lift Force*Sine (spin axis angle). The amount of lift force directed towards achieving height is: Lift Force*Cosine (spin axis angle).

A common cause of a sliced shot is the striking of the ball with an open clubface. In this case, the opening of the clubface also increases the effective loft of the club and thus increases the total spin of the ball. With all other factors held constant, a higher ball spin rate in general produces a higher lift force and this is why a slice shot often has a higher trajectory than a straight or hook shot.

The table below shows the total ball spin rates generated by a golfer with club head speeds ranging from approximately 85-105 mph using a 10.5 degree driver and hitting a variety of prototype golf balls and commercially available golf balls that are considered to be low and normal spin golf balls:

| Spin Axis, degree | Typical Total Spin, rpm | Type Shot |
|---|---|---|
| −30 | 2,500-5,000 | Strong Slice |
| −15 | 1,700-5,000 | Slice |
| 0 | 1,400-2,800 | Straight |
| +15 | 1,200-2,500 | Hook |
| +30 | 1,000-1,800 | Strong Hook |

FIG. 10 illustrates the average Carry and Total Dispersion versus the MOI difference between the minimum and maximum orientations for each dimple design (random for the TopFlite XL, which is a conforming or symmetrical ball under USGA regulations), using data obtained from robot testing using a Trackman System as referenced above. Balls 25-2, 25-3, and 25-4 of FIG. 10 (also illustrated in FIGS. 4 to 6) are related since they have basically the same dimple pattern except that each has a different number of rows of dimples surrounding the equator, with ball 25-2 having two rows on each side, ball 25-3 having four rows, and ball 25-4 having three rows. The % MOI delta between the minimum and maximum orientation for each of these balls'obtained from the data in FIG. 10 is indicated in Table 12 below.

TABLE 12

| | Rows of truncated | |
|---|---|---|
| Design | around the equator | % MOI |
| # | (per hemisphere) | Delta |
| 25-2 | 2 | 0.062% |
| 25-3 | 4 | 0.033% |
| 25-4 | 3 | 0.074% |

FIG. 11 shows the average Carry and Total Distance versus the MOI difference between the Minimum and Maximum orientations for each dimple design.

Table 13 below illustrates results from slice testing the 25-1, 28-1, and 2-9 halls as well as the Titleist ProV1 and the TopFlite XL Straight balls, with the 25-1, 28-1 and 2-9 balls tested in both the PH and POP orientations. In this table, the average values for carry dispersion, carry distance, total dispersion, total yards, and roll yards are indicated. This indicates that the 25-1, 28-1 and 2-9 balls have significantly less dispersion in the PH orientation than in the POP orientation, and also have less dispersion than the known symmetrical ProV1 and TopFlite balls which were tested.

TABLE 13
Results from 4-15-10 slice test

| | Average Values for TrackMan Data | | | | | |
|---|---|---|---|---|---|---|
| | | Carry | | Total | Total | |
| | | Dis- | Carry | Dis- | Dis- | |
| Ball | | persion, | Distance, | persion, | tance, | Roll, |
| Name | Orientation | ft | yds | ft | yds | yds |
| 25-1 | PH | 11 | 197 | 17 | 224 | 25 |
| 28-1 | PH | −8 | 194 | −5 | 212 | 18 |
| 2-9 | PH | 15 | 202 | 22 | 233 | 30 |
| 25-1 | POP | 39 | 198 | 54 | 215 | 18 |
| 28-1 | POP | 47 | 202 | 62 | 216 | 14 |
| 2-9 | POP | 65 | 194 | 79 | 206 | 13 |
| ProV1 | POP | 66 | 197 | 74 | 204 | 7 |
| TopFlite | POP | 50 | 196 | 69 | 206 | 10 |

Golf balls 25-1, 28-1, 2-9, Polara 2p 4/08, Titleist ProV1 and TopFlite XL Straight were subjected to several tests under industry standard laboratory conditions to demonstrate the better performance that the dimple patterns described herein obtain over competing golf balls. In these tests, the flight characteristics and distance performance of the golf balls 25-1, 28-1 and 2-9 were conducted and compared with a Titleist Pro V1® made by Acushnet and TopFlite XL Straight made by Callaway Golf and a Polara 2p 4/08 made by Pounce Sports LLC. Also, each of the golf balls 25-1, 28-1, 2-9, Polara 2p 4/08, were tested in the Poles-Forward-Backward (PFB), Pole-Over-Pole (POP) and Pole Horizontal (PH) orientations. The Pro V1® and TopFlite XL Straight are USGA conforming balls and thus are known to be spherically symmetrical, and were therefore tested in no particular orientation (random orientation). Golf halls 25-1 and 28-1 were made from basically the same materials and had a DuPont HPF 2000 based core and a Surlym™ blend (50% 9150, 50% 8150) cover. The cover was approximately 0.06 inches thick.

The tests were conducted with a “Golf Laboratories” robot and hit with the same Taylor Made® driver at varying club head speeds. The Taylor Made® driver had a 10.5° R9 460 club head with a Motore 65 “S” shaft. The golf balls were hit in a random order. Further, the balls were tested under conditions to simulate an approximately 15-25 degree slice, e.g., a negative spin axis of 15-25 degrees.

FIGS. 12 and 13 are examples of the top and side view of the trajectories for individual shots from the Trackman Net system when tested as described above. The Trackman trajectory data in FIGS. 12 and 13 clearly shows the 28-1, 25-1 and 2-9 balls in orientation were much straighter (less dispersion) and lower flying (lower trajectory height). The maximum trajectory height data in FIG. 13 correlates directly with the lift coefficient (CL) produced by each golf ball. The results indicate that the Pro V1® and TopFlite straight golf hail generated more lift than the 28-1, 25-1 or 2-9 balls in the PH orientation.

### Lift and Drag Coefficient Testing & Results, CL and CD Regressions

FIGS. 14-17 show the lift and drag coefficients (CL and CD) versus Reynolds Number (Re) at spin rates of 3,500 rpm and 4,500 rpm respectively, for the 25-1, 28-1 and 2-9 dimple designs as well as for the TopFlite® XL Straight, Polara 2p and Titleist Pro V1®. The curves in each graph were generated from the regression analysis of multiple straight shots for each ball design in a specific orientation.

The curves in FIGS. 14-17 depict the results of regression analysis of many shots over the course of testing done in the period from January through April 2010 under a variety of spin and Reynolds Number conditions. To obtain the regression data shown in FIGS. 14 to 17, a Trackman Net System consisting of 3 radar units was used to track the trajectory of a golf ball that was struck by a Golf Labs robot equipped with various golf clubs. The robot was set up to hit a straight shot with various combinations of initial spin and velocity. A wind gauge was used to measure the wind speed at approximately 20 ft elevation near the robot location. The Trackman Net System measured trajectory data (x, y, z location vs. time) which were then used to calculate the lift coefficients (CL) and drag coefficients (CD) as a function of measured time-dependent quantities including Reynolds Number, Ball Spin Rate, and Dimensionless Spin Parameter. Each golf ball model or design was tested under a range of velocity and spin conditions that included 3,000-5,000 rpm spin rate and 120,000-180,000 Reynolds Number. A 5-term multivariable regression model for the lift and drag coefficients as a function of Reynolds Number (Re) and Dimensionless Spin Parameter (W) was then fit to the data for each ball design: The regression equations for CL and CD were:

CL_{Regression}=a₁*Re+a₂*W+a₃*Rê2+a₄*Ŵ2+a₅*ReW+a₆

CD_{Regression}=b₁*Re+b₂*W+b₃*Rê2+b₄*Ŵ2+b₅*ReW+b₆

Where aᵢ with i=1-6 are regression coefficients for Lift Coefficient and

bᵢ with i=1-6 are regression coefficients for Drag Coefficient

Typically the predicted CD and CL values within the measured Re and W space (interpolation) were in close agreement with the measured CD and CL values. Correlation coefficients of 96-99% were typical.

Below in Tables 14A and 14B are the regression constants for each ball shown in FIGS. 14-17. Using these regression constants, the Drag and Lift coefficients can be calculated over the range of 3,000-5,000 rpm spin rate and 120,000-180,000 Reynolds Number. FIGS. 14 to 17 were constructed for a very limited set of spin and Re conditions (3,500 or 4,500 rpm and varying the Re from 120,000 to 180,000), just to provide a few examples of the vast amount of data contained by the regression constants for lift and drag shown in Tables 14A and 14B. The constants can be used to represent the lift and drag coefficients at any point within the space of 3,000-5,000 rpm spin rate and 120,000-180,000 Reynolds Number.

TABLE 14A

| | | Lift Coefficient regression equation coeficient | | | | | |
|---|---|---|---|---|---|---|---|
| Ball Design# | Orientation | a4 | a3 | a5 | a2 | a1 | a6 |
| 25-1 | PH | −0.030201 | −3.98E−12 | −8.44E−07 | 0.867344 | 1.37E−06 | −0.087395 |
| 25-1 | PFB | −2.20008 | −3.94E−12 | −4.28E−06 | 2.186681 | 1.61E−06 | −0.129568 |
| 28-1 | PFB | −1.23292 | −6.02E−12 | −3.02E−06 | 1.722214 | 2.26E−06 | −0.177147 |
| 28-1 | PH | −0.88888 | −4.65E−12 | −3.49E−06 | 1.496342 | 2.15E−06 | −0.22382 |
| Polara 2p 4/08 | PH | −0.572601 | −2.02E−11 | −6.63E−06 | 1.303124 | 6.1E−06 | −0.231079 |
| Polara 2p 4/08 | PFB | −1.396513 | −7.39E−12 | −2.82E−06 | 1.612026 | 2.34E−06 | −0.140899 |
| Titleist ProV1 | na | −0.996621 | −4.01E−12 | −1.83E−06 | 1.251743 | 1.08E−06 | 0.018157 |
| 2-9-121909 | PFB | −0.564838 | −2.73E−12 | 8.44E−07 | 0.592334 | 1.78E−07 | 0.161622 |
| 2-9-121909 | PH | −3.198559 | −8.57E−12 | −8.56E−06 | 2.945159 | 3.57E−06 | −0.349143 |
| TopFlite XL-Str | NA | −0.551398 | 1.48E−12 | 1.76E−06 | 0.61879 | −1.08E−06 | 0.222013 |

TABLE 14B

| | | Drag Coefficient regression equation coeficient | | | | | |
|---|---|---|---|---|---|---|---|
| Ball Design# | Orientation | b4 | b3 | b5 | b2 | b1 | b6 |
| 25-1 | PH | 0.369982 | −3.16E−12 | −1.81E−07 | 0.278718 | 9.28E−07 | 0.139166 |
| 25-1 | PFB | −0.149176 | −1.64E−12 | 3.04E−07 | 0.66705 | 5.35E−07 | 0.126985 |
| 28-1 | PFB | 0.431796 | −1.62E−12 | 8.56E−07 | 0.25899 | 2.76E−07 | 0.200928 |
| 28-1 | PH | 0.84062 | −2.23E−12 | 8.84E−07 | −0.135614 | 4.23E−07 | 0.226051 |
| Polara 2p 4/08 | PH | −1.086276 | 4.01E−12 | −2.33E−06 | 1.194892 | −2.7E−07 | 0.157838 |
| Polara 2p 4/08 | PFB | −0.620696 | −3.52E−12 | −1.3E−06 | 0.965054 | 1.2E−06 | 0.043268 |
| Titleist ProV1 | na | −0.632946 | 2.37E−12 | 7.04E−07 | 0.761151 | −7.41E−07 | 0.195108 |
| 2-9-121909 | PFB | −0.822987 | 1.57E−13 | 2.61E−06 | 0.509 | −4.46E−07 | 0.224937 |
| 2-9-121909 | PH | 2.145845 | −3.66E−12 | −8.88E−07 | −0.110029 | 1.14E−06 | 0.130302 |
| TopFlite XL-Str | NA | −0.373608 | −1.38E−12 | 1.85E−07 | 0.663666 | 3.5E−07 | 0.14574 |

As can be determined from FIGS. 14 to 17, the lift coefficient for balls 25-1, 28-1 and 2-9 in a pole horizontal (PH) orientation is between 0.10 and 0.14 at a Reynolds number (Re) of 180,000 and a spin rate of 3,500 rpm, and between 0.14 and 0.20 at a Re of 120,000 and spin rate of 3,500, which is less than the CL of the other three tested balls (Polara 2p 0408 PH and PFB, Titleist ProV1 and TopFlite XL random orientation). The lift coefficient or CL of the 28-1, 25-1 and 2-9 balls in a PH orientation at a spin rate of 4,500 rpm is between 0.13 and 0.16 at an Re of 180,000 and between 0.17 and 0.25 at an Re of 120,000, as seen in FIG. 15. Drag Coefficients (CD) for the 28-1, 2-9 and 25-1 balls in PH Orientation at a spin rate of 3,500 rpm are between 0.23 and 0.26 at an Re of 150,000 and between about 0.24 and 0.27 at an Re of 120,000 as illustrated in FIG. 16. CDs for the same balls at a spin rate of 4,500 rpm (FIG. 17) are about 0.28 to 0.29 at an Re of 120,000 and about 0.23 to 0.26 at an Re of 180,000.

Under typical slice conditions, with spin rates of 3,000 rpm or greater, the 2-9, 25-1, 28-1 in PH orientation and the Polara 2p in PFB orientation exhibit lower lift coefficients than the commercial halls: ProV1 and TopFlite XL Straight. Lower lift coefficients translate into lower trajectory for straight shots and less dispersion for slice shots. Balls with dimple patterns 2-9, 25-1, 28-1 in PH orientation have approximately 10-40% lower lift coefficients than the ProV1 and TopFlite XL Straight under Re and spin conditions characteristics of slice shots.

Tables 15-17 are the Trackman Report from the Robot Test. The robot was set up to hit a slice shot with a club path of approximately 7 degrees outside-in and a slightly opened club face. The club speed was approximately 98-100 mph, initial ball spin ranged from about 3,800-5,200 rpm depending on ball construction and the spin axis was approximately 13-21 degrees.

TABLE 15

| | | | | | | | Vert. | Horiz. | | |
|---|---|---|---|---|---|---|---|---|---|---|
| | | | | Club | Attack | Club | Swing | Swing | Dyn. | Face |
| Shot | Ball ID w | | | Speed | Angle | Path | Plane | Plane | Loft | Angle |
| No | Orientation | ball Design | orient | [mph] | [deg] | [deg] | [deg] | [deg] | [deg] | [deg] |
| 153 | 903PH | 2-9 | H | 95.8 | −6.1 | −6.8 | 55.7 | −11.0 | 10.5 | −4.6 |
| 156 | 902PH | 2-9 | H | 95.1 | −6.6 | −6.9 | 55.9 | −11.4 | 10.7 | −3.3 |
| 158 | 908PH | 2-9 | H | 99.1 | −6.1 | −7.0 | 56.7 | −11.0 | 10.5 | −3.7 |
| 173 | 908H | 2-9 | H | 101.9 | −6.5 | −7.3 | 56.7 | −11.6 | 10.2 | −4.2 |
| 175 | 907H | 2-9 | H | 99.7 | −5.5 | −7.6 | 56.4 | −11.2 | 10.4 | −3.5 |
| 179 | 902H | 2-9 | H | 96.7 | −5.6 | −6.5 | 56.9 | −10.2 | 10.3 | −4.4 |
| 185 | 907H | 2-9 | H | 98.7 | | | | | | |
| 191 | 908H | 2-9 | H | 98.2 | −5.9 | −7.7 | 54.9 | −11.8 | 9.8 | −3.7 |
| 155 | 904POP | 2-9 | POP | 96.8 | −5.7 | −7.6 | 55.6 | −11.5 | 10.2 | −4.0 |
| 157 | 906POP | 2-9 | POP | 99.2 | −6.0 | −7.7 | 55.4 | −11.8 | 10.6 | −4.6 |
| 159 | 905POP | 2-9 | POP | 98.9 | −5.6 | −7.7 | 55.5 | −11.5 | 10.3 | −5.0 |
| 177 | 902POP | 2-9 | POP | 98.8 | −5.2 | −6.8 | 57.3 | −10.1 | 10.1 | −3.9 |
| 178 | 906POP | 2-9 | POP | 99.4 | −6.0 | −7.6 | 55.0 | −11.8 | 10.3 | −3.7 |
| 187 | 901POP | 2-9 | POP | 98.5 | −5.9 | −7.8 | 55.3 | −11.8 | 10.2 | −2.7 |
| 188 | 906POP | 2-9 | POP | 101.1 | −6.4 | −7.4 | 54.0 | −12.1 | 10.2 | −4.5 |
| 196 | 904POP | 2-9 | POP | | | | | | | |
| 142 | 505PH | 25-1 | H | 100.1 | −6.6 | −7.7 | 54.4 | −12.5 | 10.9 | −4.0 |
| 143 | 502PH | 25-1 | H | | | | | | | |
| 145 | 506PH | 25-1 | H | 100.3 | −5.6 | −8.0 | 55.8 | −11.8 | 10.7 | −3.4 |
| 149 | 501PH | 25-1 | H | 98.9 | −5.7 | −7.5 | 56.2 | −11.3 | 10.3 | −4.9 |
| 160 | 502H | 25-1 | H | 100.0 | −6.0 | −7.7 | 55.2 | −11.8 | 10.7 | −4.1 |
| 163 | 506H | 25-1 | H | | | | | | | |
| 165 | 501H | 25-1 | H | 99.0 | −5.7 | −7.8 | 55.9 | −11.7 | 10.1 | −4.7 |
| 170 | 505H | 25-1 | H | 100.7 | −5.3 | −7.9 | 55.7 | −11.5 | 10.2 | −4.3 |
| 184 | 506H | 25-1 | H | 98.8 | −5.6 | −7.7 | 55.6 | −11.5 | 10.3 | −3.3 |
| 186 | 502H | 25-1 | H | 99.1 | −5.7 | −7.9 | 54.7 | −11.9 | 10.4 | −4.1 |
| 193 | 502H | 25-1 | H | 98.7 | −5.8 | −7.5 | 55.0 | −11.6 | 10.0 | −4.3 |
| 197 | 501PH | 25-1 | H | | | | | | | |
| 224 | 516H | 25-1 | H | 99.0 | −5.7 | −7.6 | 55.4 | −11.5 | 10.5 | −4.4 |
| 192 | 503PFB | 25-1 | PFB | 99.6 | −5.7 | −7.9 | 54.6 | −11.9 | 10.3 | −4.6 |
| 141 | 503POP | 25-1 | POP | 98.9 | −5.8 | −7.7 | 56.2 | −11.6 | 11.0 | −3.1 |
| 144 | 505POP | 25-1 | POP | 98.8 | −5.7 | −7.8 | 55.8 | −11.7 | 11.1 | −3.3 |
| 150 | 508POP | 25-1 | POP | 98.8 | −5.6 | −7.9 | 56.3 | −11.6 | 10.3 | −3.1 |
| 151 | 507POP | 25-1 | POP | 98.9 | −5.7 | −7.8 | 55.9 | −11.7 | 11.2 | −3.3 |
| 161 | 508POP | 25-1 | POP | 99.5 | −5.5 | −7.9 | 54.8 | −11.8 | 10.1 | −4.3 |
| 162 | 507POP | 25-1 | POP | 99.1 | −5.5 | −7.6 | 55.4 | −11.4 | 10.7 | −4.2 |
| 166 | 504POP | 25-1 | POP | 99.0 | −5.6 | −7.8 | 55.9 | −11.6 | 10.9 | −3.5 |
| 171 | 503POP | 25-1 | POP | 99.0 | −5.7 | −7.8 | 56.3 | −11.6 | 10.9 | −4.1 |
| 182 | 504P | 25-1 | POP | 98.9 | −5.8 | −7.8 | 55.3 | −11.8 | 10.5 | −3.4 |
| 183 | 507POP | 25-1 | POP | 98.9 | −5.7 | −7.8 | 55.8 | −11.7 | 10.2 | −3.5 |
| 189 | 508POP | 25-1 | POP | 99.1 | −5.7 | −7.5 | 54.7 | −11.6 | 10.7 | −3.3 |
| 169 | 802F | 28-1 | F | 98.3 | −5.1 | −8.2 | 56.4 | −11.6 | 10.6 | −3.4 |
| 231 | 814F | 28-1 | F | 98.9 | −5.7 | −7.8 | 56.0 | −11.7 | 10.9 | −3.5 |
| 146 | 803PH | 28-1 | H | 99.2 | −5.8 | −7.9 | 56.0 | −11.8 | 10.7 | −3.2 |
| 167 | 803H | 28-1 | H | 99.0 | −5.4 | −7.6 | 56.0 | −11.3 | 10.4 | −3.8 |
| 195 | 803H | 28-1 | H | 98.8 | −5.6 | −7.7 | 55.6 | −11.5 | 8.8 | −4.0 |
| 199 | 812H | 28-1 | H | 98.8 | −6.2 | −7.4 | 54.5 | −11.8 | 9.4 | −3.8 |
| 208 | 815H | 28-1 | H | 98.8 | −5.9 | −7.5 | 54.9 | −11.7 | 10.5 | −4.0 |
| 233 | 811H | 28-1 | H | 99.3 | −6.1 | −7.4 | 55.8 | −11.6 | 11.1 | −3.6 |
| 194 | 801PFB | 28-1 | PFB | 98.7 | −5.5 | −7.9 | 55.0 | −11.7 | 10.4 | −4.0 |
| 147 | 802POP | 28-1 | POP | | | | | | | |
| 148 | 801POP | 28-1 | POP | 98.8 | −5.7 | −7.9 | 56.0 | −11.8 | 10.9 | −3.4 |
| 164 | 801POP | 28-1 | POP | 97.6 | −6.5 | −7.1 | 55.0 | −11.6 | 10.8 | −4.0 |
| 181 | 802POP | 28-1 | POP | 98.5 | −5.2 | −8.0 | 56.2 | −11.5 | 10.4 | −2.7 |
| 205 | V140 | Titleist ProV1 | na | 98.8 | −5.7 | −7.5 | 54.7 | −11.6 | 10.2 | −4.4 |
| 212 | V92 | Titleist ProV1 | na | 98.8 | −5.6 | −7.7 | 54.7 | −11.6 | 10.4 | −4.5 |
| 219 | V95 | Titleist ProV1 | na | 99.3 | −5.8 | −7.5 | 54.4 | −11.7 | 10.4 | −4.6 |
| 237 | V76 | Titleist ProV1 | na | 98.9 | −6.1 | −8.1 | 54.9 | −12.4 | 10.6 | −3.5 |
| 241 | V180 | Titleist ProV1 | na | 97.6 | −5.7 | −7.0 | 56.5 | −10.8 | 11.0 | −4.4 |
| 243 | V97 | Titleist ProV1 | na | 99.3 | −5.6 | −7.8 | 56.1 | −11.5 | 10.5 | −4.2 |
| 198 | 224 | TopFlite XL Straight | na | 99.3 | −6.3 | −7.0 | 53.4 | −11.7 | 10.3 | −4.7 |
| 207 | 225 | TopFlite XL Straight | na | 98.7 | −6.1 | −7.6 | 55.3 | −11.8 | 10.4 | −3.6 |
| 215 | 223 | TopFlite XL Straight | na | 96.5 | −5.2 | −7.6 | 56.5 | −11.0 | 10.4 | −4.2 |
| 222 | 227 | TopFlite XL Straight | na | 98.8 | −6.2 | −6.9 | 54.1 | −11.4 | 10.2 | −4.7 |
| 236 | 185 | TopFlite XL Straight | na | 98.8 | −4.6 | −8.7 | 56.1 | −11.8 | 10.2 | −3.3 |
| 248 | 222 | TopFlite XL Straight | na | 98.9 | −7.0 | −6.5 | 56.1 | −11.2 | 10.8 | −3.6 |

TABLE 16

| | Ball | Smash | Vert. | Horiz. | Drag | Lift | Spin | Spin | Max | Max | Max |
|---|---|---|---|---|---|---|---|---|---|---|---|
| Shot | Speed | factor | Angle | Angle | Coef. | Coef. | Rate | Axis | Height x | Height y | Height z |
| No | [mph] | [ ] | [deg] | [deg] | [ ] | [ ] | [rpm] | [deg] | [yds] | [yds] | [yds] |
| 153 | 142.8 | 1.49 | 7.6 | 5.0L | 0.26 | 0.19 | 4212 | 21.0 | 129.9 | 17.6 | 0.5L |
| 156 | 141.2 | 1.48 | 8.0 | 4.0L | 0.24 | 0.16 | 4048 | 12.6 | 129.4 | 15.9 | 3.9L |
| 158 | 141.8 | 1.43 | 7.8 | 4.3L | 0.23 | 0.15 | 4013 | 16.1 | 132.1 | 15.7 | 3.5L |
| 173 | 143.3 | 1.41 | 7.4 | 4.6L | 0.27 | 0.21 | 4105 | 19.7 | 132.6 | 20.3 | 2.6R |
| 175 | 142.0 | 1.42 | 7.4 | 4.4L | 0.26 | 0.18 | 4459 | 16.9 | 132.3 | 18.1 | 0.1L |
| 179 | 141.4 | 1.46 | 7.5 | 5.1L | 0.24 | 0.16 | 4017 | 19.3 | 128.3 | 15.2 | 3.0L |
| 185 | 141.3 | 1.43 | 7.7 | 3.9L | 0.25 | 0.16 | 3922 | 16.4 | 126.7 | 15.1 | 2.2L |
| 191 | 142.5 | 1.45 | 7.3 | 4.3L | 0.26 | 0.17 | 3899 | 18.4 | 131.4 | 17.1 | 0.8R |
| 155 | 143.0 | 1.48 | 7.1 | 4.7L | 0.29 | 0.22 | 4472 | 22.1 | 128.2 | 19.7 | 4.9R |
| 157 | 143.0 | 1.44 | 7.9 | 5.1L | 0.28 | 0.20 | 3943 | 22.4 | 127.6 | 19.8 | 3.6R |
| 159 | 142.4 | 1.44 | 7.5 | 5.5L | 0.26 | 0.21 | 4063 | 23.0 | 130.0 | 19.7 | 3.9R |
| 177 | 142.6 | 1.44 | 7.2 | 4.5L | 0.29 | 0.22 | 4246 | 16.9 | 132.5 | 22.2 | 3.5R |
| 178 | 143.6 | 1.44 | 7.3 | 4.5L | 0.30 | 0.22 | 4410 | 23.6 | 127.8 | 19.6 | 6.3R |
| 187 | 142.0 | 1.44 | 7.5 | 3.6L | 0.28 | 0.21 | 4142 | 14.9 | 136.7 | 21.9 | 2.2R |
| 188 | 142.8 | 1.41 | 7.4 | 5.0L | 0.29 | 0.22 | 3974 | 21.2 | 132.5 | 22.7 | 6.4R |
| 196 | 141.8 | | 7.2 | 4.4L | 0.28 | 0.23 | 4190 | 22.0 | 131.6 | 22.5 | 9.9R |
| 142 | 144.7 | 1.45 | 7.5 | 4.9L | 0.26 | 0.15 | 5019 | 16.0 | 124.4 | 14.7 | 4.1L |
| 143 | 146.5 | | 7.4 | 4.3L | 0.26 | 0.16 | 4903 | 16.4 | 127.4 | 15.7 | 1.8L |
| 145 | 146.0 | 1.46 | 7.4 | 4.4L | 0.25 | 0.16 | 5020 | 18.7 | 128.3 | 15.5 | 1.8L |
| 149 | 146.6 | 1.48 | 7.2 | 5.5L | 0.27 | 0.19 | 4929 | 16.9 | 137.1 | 20.8 | 0.7L |
| 160 | 145.5 | 1.46 | 7.7 | 4.9L | 0.26 | 0.14 | 4644 | 13.5 | 122.2 | 14.3 | 5.5L |
| 163 | 145.8 | | 7.1 | 4.6L | 0.25 | 0.15 | 4930 | 16.9 | 125.6 | 13.9 | 3.4L |
| 165 | 147.0 | 1.49 | 7.1 | 5.4L | 0.26 | 0.18 | 4717 | 17.6 | 139.0 | 19.7 | 2.1L |
| 170 | 146.2 | 1.45 | 7.0 | 5.2L | 0.26 | 0.16 | 4962 | 16.2 | 127.6 | 15.0 | 3.7L |
| 184 | 145.7 | 1.47 | 7.0 | 4.5L | 0.27 | 0.15 | 4926 | 15.9 | 122.4 | 14.0 | 2.9L |
| 186 | 146.1 | 1.47 | 7.3 | 5.0L | 0.26 | 0.14 | 4628 | 11.2 | 119.9 | 13.4 | 6.5L |
| 193 | 146.8 | 1.49 | 6.8 | 5.0L | 0.29 | 0.18 | 4775 | 17.7 | 130.0 | 17.0 | 2.1L |
| 197 | 145.6 | | 7.1 | 4.9L | 0.26 | 0.17 | 4612 | 16.0 | 135.3 | 18.4 | 0.5L |
| 224 | 146.6 | 1.48 | 7.2 | 5.4L | 0.29 | 0.16 | 4816 | 16.5 | 125.4 | 15.7 | 4.7L |
| 192 | 145.7 | 1.46 | 7.0 | 5.3L | 0.29 | 0.20 | 4834 | 16.5 | 133.2 | 21.4 | 1.8R |
| 141 | 146.9 | 1.48 | 7.5 | 4.1L | 0.31 | 0.21 | 5169 | 18.0 | 132.5 | 22.1 | 3.8R |
| 144 | 145.9 | 1.48 | 7.8 | 4.2L | 0.28 | 0.20 | 4897 | 17.6 | 133.5 | 21.5 | 4.0R |
| 150 | 147.0 | 1.49 | 7.1 | 4.2L | 0.30 | 0.21 | 4938 | 14.5 | 133.5 | 22.0 | 1.5R |
| 151 | 146.1 | 1.48 | 7.8 | 4.4L | 0.28 | 0.19 | 5122 | 14.7 | 134.7 | 21.2 | 0.4L |
| 161 | 146.0 | 1.47 | 6.9 | 5.1L | 0.28 | 0.20 | 4813 | 21.3 | 133.7 | 19.3 | 2.4R |
| 162 | 146.4 | 1.48 | 7.3 | 5.0L | 0.29 | 0.21 | 5020 | 17.2 | 134.5 | 21.4 | 1.0R |
| 166 | 146.8 | 1.48 | 7.6 | 4.6L | 0.30 | 0.20 | 4993 | 11.8 | 133.3 | 21.6 | 0.5L |
| 171 | 147.1 | 1.48 | 7.6 | 4.9L | 0.29 | 0.21 | 5069 | 18.9 | 133.7 | 21.8 | 2.9R |
| 182 | 146.3 | 1.48 | 7.3 | 4.3L | 0.28 | 0.20 | 4779 | 19.5 | 135.3 | 21.3 | 6.8R |
| 183 | 146.1 | 1.48 | 7.1 | 4.3L | 0.30 | 0.21 | 4871 | 13.9 | 136.3 | 22.8 | 1.6R |
| 189 | 145.5 | 1.47 | 7.6 | 4.4L | 0.29 | 0.19 | 4573 | 12.5 | 129.4 | 19.4 | 1.9L |
| 169 | 145.8 | 1.48 | 6.9 | 4.7L | 0.31 | 0.21 | 5582 | 20.8 | 129.5 | 20.2 | 5.6R |
| 231 | 147.2 | 1.49 | 7.4 | 4.5L | 0.32 | 0.22 | 5353 | 15.2 | 130.3 | 23.5 | 1.8R |
| 146 | 146.7 | 1.48 | 7.5 | 4.2L | 0.27 | 0.15 | 4996 | 15.1 | 120.5 | 14.1 | 3.5L |
| 167 | 146.1 | 1.48 | 7.3 | 4.8L | 0.28 | 0.14 | 4786 | 16.7 | 114.3 | 12.8 | 4.2L |
| 195 | 145.6 | 1.47 | 7.4 | 4.5L | 0.28 | 0.14 | 4612 | 17.0 | 109.2 | 11.8 | 3.7L |
| 199 | 145.5 | 1.47 | 8.0 | 4.3L | 0.29 | 0.14 | 4513 | 9.8 | 114.1 | 13.8 | 5.6L |
| 208 | 146.6 | 1.48 | 7.3 | 4.9L | 0.29 | 0.15 | 4960 | 12.6 | 117.0 | 14.0 | 5.5L |
| 233 | 146.5 | 1.48 | 7.6 | 4.5L | 0.30 | 0.16 | 5181 | 16.7 | 119.7 | 15.1 | 3.1L |
| 194 | 146.8 | 1.49 | 7.0 | 4.9L | 0.32 | 0.22 | 5172 | 14.7 | 129.9 | 23.1 | 1.4R |
| 147 | 146.8 | | 7.2 | 4.0L | 0.30 | 0.19 | 5045 | 15.0 | 132.8 | 20.3 | 1.2R |
| 148 | 146.8 | 1.49 | 7.6 | 4.3L | 0.29 | 0.20 | 4915 | 19.8 | 133.9 | 21.2 | 5.5R |
| 164 | 146.6 | 1.50 | 7.5 | 4.6L | 0.28 | 0.18 | 4812 | 15.8 | 134.9 | 19.1 | 0.0R |
| 181 | 145.4 | 1.48 | 7.2 | 3.8L | 0.28 | 0.19 | 4748 | 16.9 | 131.9 | 18.8 | 2.4R |
| 205 | 144.9 | 1.47 | 7.3 | 5.0L | 0.27 | 0.22 | 4388 | 16.6 | 143.1 | 26.0 | 5.2R |
| 212 | 145.3 | 1.47 | 7.3 | 5.1L | 0.28 | 0.22 | 4618 | 15.1 | 142.7 | 26.6 | 3.3R |
| 219 | 145.1 | 1.46 | 7.3 | 5.2L | 0.30 | 0.23 | 4534 | 14.1 | 139.0 | 26.4 | 0.3R |
| 237 | 145.9 | 1.48 | 7.7 | 4.3L | 0.29 | 0.23 | 4400 | 14.3 | 140.8 | 28.1 | 5.5R |
| 241 | 144.7 | 1.48 | 7.9 | 5.0L | 0.29 | 0.22 | 4546 | 18.4 | 141.3 | 27.0 | 8.5R |
| 243 | 145.4 | 1.46 | 7.3 | 5.0L | 0.30 | 0.24 | 4834 | 17.8 | 139.3 | 28.0 | 8.0R |
| 198 | 145.0 | 1.46 | 7.6 | 5.1L | 0.28 | 0.22 | 3925 | 16.4 | 139.6 | 26.1 | 3.3R |
| 207 | 145.4 | 1.47 | 7.6 | 4.3L | 0.29 | 0.21 | 4254 | 14.6 | 138.9 | 24.7 | 4.4R |
| 215 | 144.5 | 1.50 | 7.4 | 4.9L | 0.30 | 0.23 | 4412 | 17.5 | 139.7 | 26.4 | 6.0R |
| 222 | 145.3 | 1.47 | 7.3 | 5.2L | 0.29 | 0.23 | 4362 | 13.3 | 140.0 | 27.3 | 1.0R |
| 236 | 145.0 | 1.47 | 7.4 | 4.5L | 0.29 | 0.23 | 4523 | 13.0 | 142.9 | 27.8 | 4.2R |
| 248 | 145.3 | 1.47 | 7.9 | 4.1L | 0.30 | 0.24 | 4424 | 12.0 | 138.7 | 31.0 | 4.5R |

TABLE 17

| | | | | | Spin | | | | | Vert. | Ball | Spin | Flight |
|---|---|---|---|---|---|---|---|---|---|---|---|---|---|
| Shot | Length | X | Side | Height | Rate | Time | Length | X | Side | Angle | Speed | Rate | Time |
| No | [yds] | [yds] | [yds] | [yds] | [rpm] | [s] | [yds] | [yds] | [yds] | [deg] | [mph] | [rpm] | [s] |
| 153 | 198.4 | 198.3 | 5.6R | −0.2 | | 5.13 | 198.1 | 198.0 | 5.5R | −31.3 | 59.7 | | 5.12 |
| 156 | 203.3 | 203.3 | 1.1L | −0.3 | | 5.05 | 202.8 | 202.8 | 1.2L | −27.4 | 60.0 | | 5.02 |
| 158 | 204.4 | 204.4 | 1.7L | −0.2 | 3180 | 5.08 | 204.1 | 204.1 | 1.7L | −27.7 | 59.5 | 3182 | 5.07 |
| 173 | 197.6 | 197.3 | 10.7R | −0.3 | 3292 | 5.35 | 197.2 | 196.9 | 10.7R | −36.1 | 59.2 | 3295 | 5.33 |
| 175 | 197.3 | 197.2 | 6.7R | −0.2 | | 5.30 | 197.0 | 196.9 | 6.6R | −33.2 | 56.9 | | 5.28 |
| 179 | 201.6 | 201.6 | 0.7R | −0.2 | | 4.90 | 201.2 | 201.2 | 0.7R | −26.1 | 63.2 | | 4.89 |
| 185 | 194.3 | 194.3 | 0.4R | −0.1 | | 4.88 | 194.1 | 194.1 | 0.4R | −28.2 | 60.2 | | 4.87 |
| 191 | 190.6 | 190.4 | 8.3R | −0.1 | 3076 | 5.19 | 190.6 | 190.4 | 8.3R | −35.3 | 54.4 | 3076 | 5.19 |
| 155 | 189.7 | 188.8 | 18.3R | 0.2 | 3714 | 5.21 | 190.0 | 189.1 | 18.3R | −36.1 | 58.8 | 3713 | 5.23 |
| 157 | 191.1 | 190.2 | 17.6R | −0.3 | 3164 | 5.18 | 190.7 | 189.9 | 17.5R | −35.3 | 60.2 | 3166 | 5.17 |
| 159 | 190.1 | 189.0 | 20.2R | 0.0 | 3247 | 5.17 | 190.1 | 189.0 | 20.2R | −36.6 | 60.5 | 3247 | 5.17 |
| 177 | 191.7 | 191.2 | 14.6R | −0.5 | 3397 | 5.53 | 191.2 | 190.6 | 14.5R | −41.0 | 58.3 | 3401 | 5.50 |
| 178 | 190.6 | 189.4 | 21.2R | 0.1 | 3598 | 5.21 | 190.8 | 189.6 | 21.3R | −35.5 | 58.5 | 3597 | 5.21 |
| 187 | 198.5 | 198.2 | 10.8R | −0.4 | 3262 | 5.72 | 198.1 | 197.8 | 10.7R | −40.7 | 54.1 | 3264 | 5.70 |
| 188 | 187.2 | 185.9 | 22.1R | 0.0 | 3116 | 5.65 | 187.2 | 185.9 | 22.1R | −43.9 | 53.8 | 3115 | 5.65 |
| 196 | 186.2 | 184.0 | 28.2R | 0.2 | | 5.65 | 186.4 | 184.2 | 28.3R | −43.3 | 54.3 | | 5.66 |
| 142 | 192.7 | 192.7 | 1.4L | −0.2 | | 4.80 | 192.3 | 192.3 | 1.4L | −27.0 | 59.7 | | 4.78 |
| 143 | 195.0 | 194.9 | 4.0R | −0.3 | | 4.91 | 194.4 | 194.4 | 3.9R | −28.8 | 59.6 | | 4.89 |
| 145 | 196.9 | 196.8 | 2.8R | −0.2 | | 4.93 | 196.4 | 196.4 | 2.7R | −28.1 | 59.4 | | 4.91 |
| 149 | 199.0 | 198.9 | 6.8R | −0.3 | 3934 | 5.56 | 198.6 | 198.5 | 6.8R | −37.7 | 56.4 | 3936 | 5.54 |
| 160 | 192.6 | 192.6 | 4.9L | −0.2 | 3702 | 4.68 | 192.3 | 192.2 | 4.9L | −25.6 | 61.8 | 3704 | 4.66 |
| 163 | 196.3 | 196.3 | 0.1L | −0.2 | | 4.74 | 195.9 | 195.9 | 0.2L | −25.2 | 60.6 | | 4.73 |
| 165 | 203.3 | 203.3 | 2.3R | −0.5 | 3709 | 5.60 | 202.7 | 202.7 | 2.3R | −36.1 | 53.7 | 3712 | 5.57 |
| 170 | 196.4 | 196.4 | 0.5R | −0.2 | 3956 | 4.85 | 196.0 | 196.0 | 0.5R | −27.3 | 60.5 | 3958 | 4.83 |
| 184 | 188.8 | 188.8 | 0.3R | −0.2 | | 4.68 | 188.5 | 188.5 | 0.3R | −26.7 | 58.5 | | 4.67 |
| 186 | 189.2 | 189.1 | 7.2L | −0.3 | 3703 | 4.50 | 188.6 | 188.4 | 7.3L | −25.0 | 62.4 | 3707 | 4.48 |
| 193 | 192.8 | 192.8 | 1.3R | −0.2 | | 5.19 | 192.5 | 192.5 | 1.2R | −33.3 | 53.4 | | 5.18 |
| 197 | 190.8 | 190.7 | 6.8R | −0.2 | 3587 | 5.54 | 190.6 | 190.4 | 6.7R | −39.4 | 49.9 | 3588 | 5.53 |
| 224 | 189.9 | 189.8 | 4.2L | −0.2 | 3777 | 5.00 | 189.5 | 189.5 | 4.2L | −30.9 | 53.1 | 3779 | 4.98 |
| 192 | 187.0 | 186.3 | 16.0R | −0.5 | 3777 | 5.70 | 186.5 | 185.8 | 15.8R | −43.2 | 50.7 | 3781 | 5.67 |
| 141 | 195.0 | 194.3 | 16.7R | −0.2 | 4093 | 5.63 | 194.8 | 194.1 | 16.6R | −38.6 | 55.5 | 4095 | 5.62 |
| 144 | 196.4 | 195.5 | 19.0R | 0.4 | 3950 | 5.58 | 197.0 | 196.1 | 19.1R | −37.0 | 54.4 | 3948 | 5.60 |
| 150 | 198.0 | 197.6 | 12.6R | −0.5 | 3920 | 5.58 | 197.4 | 197.0 | 12.5R | −37.6 | 56.8 | 3925 | 5.55 |
| 151 | 201.0 | 200.8 | 8.1R | −0.4 | 4011 | 5.65 | 200.4 | 200.3 | 8.0R | −36.6 | 53.6 | 4016 | 5.62 |
| 161 | 196.3 | 195.8 | 14.7R | −0.3 | 3854 | 5.38 | 195.9 | 195.3 | 14.6R | −35.2 | 56.8 | 3856 | 5.36 |
| 162 | 200.6 | 200.3 | 10.4R | −0.4 | 4008 | 5.52 | 200.0 | 199.8 | 10.3R | −36.3 | 58.0 | 4011 | 5.50 |
| 166 | 196.2 | 195.9 | 9.7R | −0.3 | 3934 | 5.62 | 195.8 | 195.6 | 9.6R | −38.4 | 53.4 | 3936 | 5.60 |
| 171 | 200.0 | 199.4 | 16.0R | −0.3 | 4006 | 5.54 | 199.7 | 199.0 | 16.0R | −37.1 | 56.3 | 4009 | 5.53 |
| 182 | 192.9 | 191.3 | 25.5R | 0.4 | 3714 | 5.69 | 193.4 | 191.6 | 25.7R | −40.1 | 51.7 | 3710 | 5.72 |
| 183 | 193.3 | 192.9 | 12.9R | −0.3 | 3829 | 5.79 | 193.0 | 192.6 | 12.8R | −42.8 | 53.8 | 3831 | 5.77 |
| 189 | 189.4 | 189.3 | 4.9R | −0.1 | 3545 | 5.41 | 189.3 | 189.2 | 4.9R | −38.1 | 49.9 | 3546 | 5.40 |
| 169 | 188.3 | 186.9 | 22.4R | 0.4 | 4376 | 5.46 | 188.8 | 187.4 | 22.6R | −37.7 | 52.7 | 4371 | 5.48 |
| 231 | 183.7 | 183.3 | 12.7R | −0.2 | 4123 | 5.91 | 183.5 | 183.1 | 12.7R | −46.6 | 46.7 | 4124 | 5.90 |
| 146 | 188.9 | 188.9 | 1.6L | −0.2 | 3978 | 4.55 | 188.4 | 188.4 | 1.7L | −26.2 | 61.5 | 3981 | 4.54 |
| 167 | 178.8 | 178.7 | 3.1L | 0.2 | 3846 | 4.29 | 179.1 | 179.1 | 3.1L | −25.3 | 61.2 | 3844 | 4.30 |
| 195 | 171.5 | 171.5 | 1.5L | 0.1 | | 4.10 | 171.7 | 171.7 | 1.5L | −24.5 | 60.5 | | 4.11 |
| 199 | 176.1 | 175.9 | 8.1L | 0.0 | 3524 | 4.49 | 176.0 | 175.8 | 8.1L | −28.8 | 54.9 | 3524 | 4.49 |
| 208 | 178.2 | 178.1 | 6.1L | −0.1 | 3935 | 4.56 | 178.2 | 178.1 | 6.1L | −29.6 | 55.2 | 3935 | 4.56 |
| 233 | 180.1 | 180.1 | 1.0L | 0.0 | | 4.75 | 180.1 | 180.1 | 1.0L | −31.9 | 53.0 | | 4.75 |
| 194 | 185.0 | 184.6 | 12.4R | −0.3 | 4020 | 5.77 | 184.7 | 184.3 | 12.3R | −44.2 | 49.7 | 4023 | 5.76 |
| 147 | 197.9 | 197.5 | 11.8R | −0.6 | 3957 | 5.57 | 197.1 | 196.7 | 11.6R | −36.2 | 53.7 | 3964 | 5.53 |
| 148 | 195.7 | 194.5 | 21.9R | 0.2 | 3655 | 5.58 | 195.9 | 194.7 | 22.0R | −38.6 | 53.2 | 3652 | 5.59 |
| 164 | 200.5 | 200.1 | 11.7R | −0.4 | 3760 | 5.51 | 199.8 | 199.5 | 11.6R | −34.9 | 53.1 | 3764 | 5.48 |
| 181 | 193.3 | 192.7 | 14.9R | −0.4 | 3725 | 5.41 | 192.8 | 192.2 | 14.8R | −36.1 | 52.8 | 3728 | 5.39 |
| 205 | 198.6 | 197.6 | 20.5R | 1.6 | | 6.30 | 200.1 | 199.0 | 20.8R | −48.1 | 47.3 | | 6.40 |
| 212 | 195.9 | 195.0 | 18.9R | 1.3 | 3740 | 6.39 | 197.1 | 196.1 | 19.3R | −47.9 | 47.8 | 3731 | 6.46 |
| 219 | 195.9 | 195.7 | 9.2R | −0.3 | 3695 | 6.31 | 195.7 | 195.5 | 9.2R | −46.9 | 48.9 | 3697 | 6.29 |
| 237 | 192.8 | 191.8 | 19.6R | 5.4 | 3590 | 6.12 | 197.8 | 196.7 | 20.9R | −48.5 | 49.9 | 3547 | 6.43 |
| 241 | 195.1 | 193.2 | 27.4R | 0.2 | 3680 | 6.46 | 195.3 | 193.4 | 27.4R | −49.8 | 48.3 | 3679 | 6.47 |
| 243 | 184.6 | 183.1 | 23.4R | 7.8 | | 6.02 | 191.1 | 189.4 | 25.4R | −52.4 | 47.1 | | 6.48 |
| 198 | 195.3 | 194.6 | 16.1R | 0.0 | 3231 | 6.24 | 195.3 | 194.6 | 16.1R | −47.0 | 50.0 | 3231 | 6.24 |
| 207 | 197.7 | 196.5 | 21.1R | 0.2 | | 6.24 | 197.9 | 196.8 | 21.1R | −43.5 | 48.4 | | 6.25 |
| 215 | 194.8 | 193.5 | 22.2R | −0.6 | 3582 | 6.32 | 194.3 | 193.1 | 22.0R | −48.6 | 50.8 | 3585 | 6.29 |
| 222 | 195.7 | 195.3 | 12.5R | −0.4 | 3564 | 6.41 | 195.3 | 195.0 | 12.4R | −48.4 | 49.3 | 3566 | 6.39 |
| 236 | 199.5 | 198.4 | 20.6R | 0.5 | 3622 | 6.51 | 199.9 | 198.9 | 20.8R | −48.0 | 48.4 | 3618 | 6.54 |
| 248 | 191.2 | 190.3 | 18.5R | 0.1 | 3613 | 6.60 | 191.3 | 190.4 | 18.5R | −51.4 | 50.9 | 3612 | 6.61 |

The non-conforming golf balls described above which have dimple patterns including areas of less dimple volume along at least part of a band around the equator and more dimple volume in the polar regions have a large enough moment of inertia (MOI) difference between the poles horizontal (PH) or maximum orientation and other orientations that the ball has a preferred spin axis extending through the poles of the ball. As described above, this preferred spin axis helps to prevent or reduce the amount of hook or slice dispersion when the ball is hit in a way which would normally produce hooking or slicing in a conventional, symmetrically designed golf ball. This reduction in dispersion is illustrated for the embodiments described above in FIG. 10 and for some of the embodiments in FIG. 12. Although a preferred spin axis may alternatively be established by placing high and low density materials in specific locations within the core or intermediate layers of a golf ball, such construction adds cost and complexity to the golf ball manufacturing process. In contrast, balls having the different dimple patterns described above can be readily manufactured by suitable design of the hemispherical mold cavities, for example as illustrated in FIG. 3 for a 2-9 ball.

Although the illustrated embodiments all have reduced dimple volume in a band around the equator as compared to the dimple volume in the polar regions, other dimple patterns which generate preferred spin axis may be used in alternative embodiments to achieve similar results. For example, the low volume dimples do not have to be located in a continuous band around the ball's equator. The low volume dimples could be interspersed with larger volume dimples about the equator, the band could be wider in some parts of the circumference than others, part of the band could be dimpleless around part or all of the circumference, or there may be no dimples at all around the equatorial region. Another embodiment may comprise a dimple pattern having two or more regions of lower or zero dimple volume on the surface of the ball, with the regions being somewhat co-planar. This also creates a preferred spin axis. In one example, if the two areas of lower volume dimples are placed opposite one another on the ball, then a dumbbell-like weight distribution is created. This results in a ball with a preferred spin axis equal to the orientation of the ball when rotating end-over-end with the “dumbbell” areas.

Although the dimples in the embodiments illustrated in FIGS. 1 to 8 and described above are all circular dimples, it will be understood that there is a wide variety of types and construction of dimples, including non-circular dimples, such as those described in U.S. Pat. No. 6,409,615, hexagonal dimples, dimples formed of a tubular lattice structure, such as those described in U.S. Pat. No. 6,290,615, as well as more conventional dimple types. It will also be understood that any of these types of dimples can be used in conjunction with the embodiments described herein. As such, the term “dimple” as used in this description and the claims that follow is intended to refer to and include any type or shape of dimple or dimple construction, unless otherwise specifically indicated.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A golf ball mold having an outer surface that comprise a plurality of bumps configured to form a plurality of dimples on the outer surface of a golf ball made using the tool, the mold surface comprising one or more first areas which include a plurality of first bumps which together produce a first dimple volume and at least one second area that will produce a dimple volume less that the first dimple volume, the first and second areas being configured to establish a Motion of Inertia (MOI) difference of at least 0.100 percent and a gyroscope center plane for the golf ball such that the gyroscopic center plane does not go through all of the areas.

2. The golf ball mold of claim 1, wherein the bumps are configured to produce a MOI difference in the range of about 0.100 to about 0.500 percent.

3. The golf ball mold of claim 1, wherein the bumps are configured to produce a MOI difference in the range of about 0.200 to about 0.500 percent.

4. The golf ball mold of claim 1, wherein the bumps are configured to produce a MOI difference in the range of about 0.250 to about 0.500 percent.

5. The golf ball mold of claim 1, wherein the bumps are configured to produce a MOI difference greater than about 0.200 percent.

6. The golf ball mold of claim 1, wherein the bumps are configured to produce a MOI difference greater than about 0.300 percent.

7. The golf ball mold of claim 1, wherein the humps are configured to produce a MOI difference greater than about 0.400 percent.

8. The golf ball mold of claim 1, wherein the MOI difference is calculated as the maximum moment of inertia for the golf ball minus the minimum moment of inertia divided by the maximum moment of inertia.

9. The golf ball mold of claim 8, wherein the first and second areas are configured to establish a preferred spin axis for the golf ball, and wherein the MOI is achieved when the ball is oriented so that it will spin around its preferred spin axis.

10. The golf ball mold of claim 9, wherein the minimum moment of inertia is achieved when the ball is not oriented such that it will spin around its preferred spin axis.

11. The golf ball mold of claim 9, wherein the orientation that produces spin around the preferred spin axis is the Poles Horizontal (PH) orientation.
